(19) United States
(12) Patent Application Publication
(10) Pub. No.: US 2002/0164816 A1
(43) Pub. Date: Nov. 7, 2002

(54) Microfluidic sample separation device

(75) Inventor: Stephen R. Quake, San Marino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: California Institute of Technology, Pasadena, CA

(21) Appl. No.: 10/118,461

(22) Filed: Apr. 5, 2002

Related U.S. Application Data
(60) Provisional application No. 60/281,996, filed on Apr. 6, 2001.

(51) Int. Cl. G01N 30/02

(52) U.S. Cl. 436/161; 436/174; 436/177; 436/178; 436/180; 422/58; 422/70; 422/100; 422/101; 422/103; 210/656; 210/198.2

(57) ABSTRACT

The present invention provides microfluidic chromatography devices for separating an analyte from a sample solution, and methods for producing and using the same. In particular, the present invention relates to microfluidic devices which comprise a microfabricated flow channel and a material delivery system for transporting a material through the flow channel. The flow channel comprises a chromatography column portion having a solid stationary phase which is capable of separating at least a portion of the analyte from the sample solution.

### CROSS-REFERENCES TO RELATED APPLICATIONS

This application claims the benefit of U.S. Provisional Application No. 60/281,996, filed Apr. 6, 2001, which is incorporated herein by reference in its entirety.

### STATEMENT REGARDING FEDERALLY SPONSORED RESEARCH

The U.S. Government has a paid-up license in this invention and the right in limited circumstances to require the patent owner to license others on reasonable terms as provided for by the terms of Grant No. HG-01642-02, awarded by the National Institutes of Health.

### FIELD OF THE INVENTION

The present invention relates to a microfluidic device for separating an analyte from a sample solution, and a method for producing and using the same. In particular, the present invention relates to a microfluidic device which comprises a chromatography column portion within its microfabricated flow channel.

### BACKGROUND OF THE INVENTION

Microfluidic devices have become increasing valuable in a variety of pharmaceutical research including analysis, preparation and synthesis of chemical compounds. By definition, microfluidic devices have extremely small overall volumes, and allow the manipulation of extremely small volumes of liquids. For many applications, such as high throughput screening, chemical synthesis, drug discovery, etc., the chemical make up of the resulting material needs to be analyzed. In many instances, at least some degree of sample purification and/or separation is needed for analysis. However, due to the small sample size (e.g., nanoliter to microliter) used by these microfluidic devices, conventional separation techniques are not applicable. For example, most microfluidic devices are incapable of accurately dispensing fluid volumes substantially less than a microliter, and therefore, sample separation on microliter scale is extremely difficult using current microfluidic devices. Sample separation using microfluidic device is especially difficult in processes that are based on affinity, size, mobility, or other chromatographic properties.

It would therefore be desirable to provide microfluidic devices that are capable of separating samples using a chromatographic process. Of particular interest would be a microfluidic device, as well as methods for using such devices for performing separation of a particular sample (i.e., analyte) within a microfluidic format. The present invention meets these and many other needs.

### SUMMARY OF THE INVENTION

One aspect of the present invention provides, a microfluidic device for separating an analyte from a sample fluid comprising:

(a) a microfabricated flow channel comprising:

(i) an inlet for introducing a material into said flow channel;

(ii) an outlet for removing the material from said flow channel;

(iii) a chromatography column portion located within said flow channel and in between the inlet and the outlet, and

(iv) a solid stationary phase within at least a portion of said chromatography column portion, wherein said solid stationary phase is capable of separating at least a portion of an analyte from a sample fluid; and

(b) a flow control system for regulating fluid flow through said flow channel.

Preferably, the microfluidic device is is produced from a material comprising an elastomeric polymer. In this manner the flow control system can be produced from the elastomeric polymer itself. In one particular embodiment, the flow control system comprises:

(i) a flow control channel;

(ii) a flow control valve comprised of an elastomeric segment that is disposed in between said flow channel and said flow control channel, wherein said flow control valve is deflectable into or retractable from said flow channel upon which said flow control valve operates in response to an actuation force applied to said flow control channel, the elastomeric segment when positioned in said flow channel restricting fluid flow therethrough, and

(iii) a flow control channel actuation system operatively interconnected to said flow control channel for applying the actuation force to said flow control channel.

The microfluidic devices can include a variety of other components depending on a particular need. Thus, in one embodiment, the microfluidic device also include a solid stationary phase inlet in fluid communication with said flow channel for introducing said solid stationary phase into said chromatography column portion; a solid stationary phase inlet channel interconnecting said solid stationary phase inlet and said flow channel; and a solid stationary phase inlet control valve comprised of an elastomeric segment that is disposed in between said solid stationary phase inlet channel and said control channel to regulate flow of solid stationary phase through said solid stationary phase inlet channel, wherein said solid stationary phase inlet control valve is deflectable into or retractable from said solid stationary phase inlet channel upon which said solid stationary phase inlet control valve operates in response to an actuation force applied to said control channel, the elastomeric segment of said solid stationary phase inlet control valve when positioned in said solid stationary phase inlet channel restricting flow of solid stationary phase material therethrough.

The microfluidic device can also comprise a solid stationary phase reservoir in fluid communication with said flow channel for storing the solid stationary phase material; and a solid stationary phase reservoir control valve comprised of an elastomeric segment that is disposed in between said solid stationary phase reservoir and said control channel to regulate flow of solid stationary phase into said flow channel, wherein said solid stationary phase reservoir control valve is deflectable into or retractable from said flow channel upon which said solid stationary phase reservoir control valve operates in response to an actuation force applied to said control channel, the elastomeric segment of said solid stationary phase reservoir control valve when positioned in said flow channel restricting flow of solid stationary phase material therethrough.

The microfluidic device can also include an excess solid stationary phase outlet located downstream from said chromatography column portion and in fluid communication with said flow channel for removing any excess solid stationary phase flowing out of said chromatography column portion; and an excess solid stationary phase outlet control valve comprised of an elastomeric segment that is disposed in between said excess solid stationary phase outlet and said control channel to regulate flow of solid stationary phase from said chromatography column portion to said excess solid stationary phase outlet, wherein said excess solid stationary phase outlet control valve is deflectable into or retractable from said flow channel upon which said excess solid stationary phase outlet control valve operates in response to an actuation force applied to said control channel, the elastomeric segment of said excess solid stationary phase outlet control valve when positioned in said flow channel restricting flow of excess solid stationary phase material therethrough.

The microfluidic device can further include a sample reservoir located upstream from said chromatography column portion and in fluid communication with said flow channel.

The microfluidic device can also comprise a sample inlet control valve comprised of an elastomeric segment that is disposed in between said inlet and said control channel to regulate flow of the sample into said flow channel, wherein said sample inlet control valve is deflectable into or retractable from said flow channel upon which said sample inlet control valve operates in response to an actuation force applied to said control channel, the elastomeric segment of said sample inlet control valve when positioned in said flow channel restricting sample flow therethrough.

The microfluidic device can include an eluent inlet located upstream from said chromatography column portion and in fluid communication with said flow channel for introducing an eluent into said chromatography column portion; and an eluent inlet control valve comprised of an elastomeric segment that is disposed in between said eluent inlet and said control channel to regulate flow of the eluent into said flow channel, wherein said eluent inlet control valve is deflectable into or retractable from said flow channel upon which said eluent inlet control valve operates in response to an actuation force applied to said control channel, the elastomeric segment of said eluent inlet control valve when positioned in said flow channel restricting eluent flow therethrough.

The microfluidic device can include an eluent reservoir located upstream from said chromatography column portion and in fluid communication with said flow channel.

In one particular embodiment, the microfabricated flow channel comprises a plurality of said chromatography column portions.

Yet in another embodiment, the distal end of the chromatography column portion is tapered to prevent or reduce the amount of solid stationary phase from flowing out of the chromatography column portion.

The chromatography column portion can also include a microfabricated rotary channel in fluid communication with said flow channel, wherein said rotary channel comprises:

a rotary channel inlet;

a rotary channel outlet;

a rotary inlet control valve comprised of an elastomeric segment disposed in between said rotary channel inlet and said control channel to regulate fluid flow into said rotary channel, wherein said rotary inlet control valve is deflectable into or retractable from said rotary channel inlet upon which said rotary inlet control valve operates in response to an actuation force applied to said control channel, said elastomeric segment of said rotary inlet control valve when positioned in said rotary channel inlet restricting fluid flow therethrough;

a rotary outlet control valve comprised of an elastomeric segment disposed in between said rotary channel outlet and said control channel to regulate fluid flow out of said rotary channel, wherein said rotary outlet control valve is deflectable into or retractable from said rotary channel outlet upon which said rotary outlet control valve operates in response to an actuation force applied to said control channel, said elastomeric segment of said rotary control channel outlet valve when positioned in said rotary channel outlet restricting fluid flow therethrough; and

a rotary pump valve comprised of an elastomeric segment disposed in between said rotary channel and said control channel to regulate fluid flow through said rotary channel, wherein said rotary pump valve is deflectable into or retractable from said rotary channel upon which said rotary pump valve operates in response to an actuation force applied to said control channel, said elastomeric segment of said rotary pump valve when positioned in said rotary channel restricting fluid flow therethrough.

Another aspect of the present invention provides, a method for separating an analyte from a sample solution, said method comprising the steps of:

(a) introducing a sample solution into a microfluidic device comprising:

(i) a microfabricated flow channel comprising:

(A) an inlet for introducing a material into said flow channel;

(B) an outlet for removing the material from said flow channel;

(C) a chromatography column portion located within said flow channel and in between the inlet and the outlet, and

(D) a solid stationary phase within at least a portion of said chromatography column portion, wherein said solid stationary phase is capable of separating at least a portion of an analyte from a sample fluid; and

(ii) a flow control system for regulating fluid flow through said flow channel; and

(b) eluting the sample solution through the chromatography column portion with an eluent using the flow control system, whereby at least a portion of the analyte is separated from the sample solution.

Preferably, the microfluidic device is produced from a material comprising an elastomeric polymer. In this manner the flow control system can be produced from the elastomeric polymer itself. In one particular embodiment, the flow control system comprises (i) a flow control channel; (ii) a flow control valve comprised of an elastomeric segment that is disposed in between the flow channel and the flow control channel, wherein the flow control valve is deflectable into or retractable from the flow channel upon which the flow control valve operates in response to an actuation force applied to the flow control channel, the elastomeric segment when positioned in the flow channel restricting fluid flow therethrough, and (iii) a flow control channel actuation system operatively interconnected to the flow control channel for applying the actuation force to the flow control channel.

In one particular embodiment, tthe sample solution is eluted through the chromatography column by actuating the one or more of the control control channels.

In another embodiment, the solid stationary phase is placed into the chromatography column portion prior to introducing the sample solution into the chromatography column portion. In one specific embodiment, the solid stationary phase is placed into the chromatography column portion using the flow control system.

Yet in another embodiment, the microfluidic device further comprises a solid stationary phase inlet in fluid communication with said flow channel for introducing said solid stationary phase into said chromatography column portion; a solid stationary phase inlet channel interconnecting said solid stationary phase inlet and said flow channel; a solid stationary phase inlet control valve comprised of an elastomeric segment that is disposed in between said solid stationary phase inlet channel and said control channel to regulate flow of solid stationary phase through said solid stationary phase inlet channel, wherein said solid stationary phase inlet control valve is deflectable into or retractable from said solid stationary phase inlet channel upon which said solid stationary phase inlet control valve operates in response to an actuation force applied to said control channel, the elastomeric segment of said solid stationary phase inlet control valve when positioned in said solid stationary phase inlet channel restricting flow of solid stationary phase material therethrough.

Still in another embodiment, the chromatography column portion comprises a microfabricated rotary channel in fluid communication with the flow channel, wherein the rotary channel comprises a rotary channel inlet; a rotary channel outlet; a rotary inlet control valve comprised of an elastomeric segment disposed in between the rotary channel inlet and the control channel to regulate fluid flow into the rotary channel, wherein the rotary inlet control valve is deflectable into or retractable from the rotary channel inlet upon which the rotary inlet control valve operates in response to an actuation force applied to the control channel, the elastomeric segment of the rotary inlet control valve when positioned in the rotary channel inlet restricting fluid flow therethrough; a rotary outlet control valve comprised of an elastomeric segment disposed in between the rotary channel outlet and the control channel to regulate fluid flow out of the rotary channel, wherein the rotary outlet control valve is deflectable into or retractable from the rotary channel outlet upon which the rotary outlet control valve operates in response to an actuation force applied to the control channel, the elastomeric segment of the rotary control channel outlet valve when positioned in the rotary channel outlet restricting fluid flow therethrough; and a rotary pump valve comprised of an elastomeric segment disposed in between the rotary channel and the control channel to regulate fluid flow through the rotary channel, wherein the rotary pump valve is deflectable into or retractable from the rotary channel upon which the rotary pump valve operates in response to an actuation force applied to the control channel, the elastomeric segment of the rotary pump valve when positioned in the rotary channel restricting fluid flow therethrough. Thus, in one particular embodiment, the sample solution is introduced into the rotary channel, and eluted with a first eluent to removed materials that are not bound to the solid stationary phase that is present within the rotary channel. Thereafter, the rotary channel is eluted with a second eluent to removed materials that were bound to the solid stationary phase.

In one particular embodiment, both of the rotary outlet control valve and the rotary inlet control valve are actuated after introducing the sample solution into the rotary channel. In this manner a closed system is achieved within the rotary channel. The sample solution is then circulated through the rotary channel to allow binding of an analyte to the solid stationary phase. After circulating the sample solution through the rotary channel, the first eluent is introduced into the rotary channel and any unbound material is removed from the rotary channel.

After eluting the rotary channel with the first eluent, one can add the second eluent to the rotary channel and actuate both the rotary outlet control valve and the rotary inlet control valve, thereby creating a closed system. This second eluent can then be circulated through the rotary channel to remove the bound material from the solid stationary phase. After circulating the second eluent through the rotary channel for a particular period, the second eluent is then removed from the rotary channel, thereby removing the bound material from the rotary channel.

### BRIEF DESCRIPTION OF THE DRAWINGS

FIG. 1 is a schematic illustration of a microfluidic chromatography device of the present invention.

FIG. 2 is a schematic illustration of flow channels comprising a various aspects of control and plumbing systems.

FIG. 3 is an illustration of a rotary flow channel.

FIG. 4 is an illustration of pressure plates for maintaining structural integrity of the microfluidic device under an extreme pressurization of the flow channel.

FIG. 5 is an illustration of a first elastomeric layer formed on top of a micromachined mold.

FIG. 6 is an illustration of a second elastomeric layer formed on top of a micromachined mold.

FIG. 7 is an illustration of the elastomeric layer of FIG. 6 removed from the micromachined mold and positioned over the top of the elastomeric layer of FIG. 5

FIG. 8 is an illustration corresponding to FIG. 7, but showing the second elastomeric layer positioned on top of the first elastomeric layer.

FIG. 9 is an illustration corresponding to FIG. 8, but showing the first and second elastomeric layers bonded together.

FIG. 10 is an illustration corresponding to FIG. 9, but showing the first micromachine mold removed and a planar substrate positioned in its place.

FIG. 11A is an illustration corresponding to FIG. 10, but showing the elastomeric structure sealed onto the planar substrate.

FIGS. 11B is a front sectional view corresponding to FIG. 11A, showing an open flow channel.

FIG. 11C corresponds to FIG. 11A, but shows a first flow channel closed by pressurization in second flow channel.

FIG. 12 is an illustration of a first elastomeric layer deposited on a planar substrate.

FIG. 13 is an illustration showing a first sacrificial layer deposited on top of the first elastomeric layer of FIG. 12.

FIG. 14 is an illustration showing the system of FIG. 13, but with a portion of the first sacrificial layer removed, leaving only a first line of sacrificial layer.

FIG. 15 is an illustration showing a second elastomeric layer applied on top of the first elastomeric layer over the first line of sacrificial layer of FIG. 14, thereby encasing the sacrificial layer between the first and second elastomeric layers.

FIG. 16 corresponds to FIG. 15, but shows the integrated monolithic structure produced after the first and second elastomer layers have been bonded together.

FIG. 17 is an illustration showing a second sacrificial layer deposited on top of the integral elastomeric structure of FIG. 16.

FIG. 18 is an illustration showing the system of FIG. 17, but with a portion of the second sacrificial layer removed, leaving only a second line of sacrificial layer.

FIG. 19 is an illustration showing a third elastomer layer applied on top of the second elastomeric layer and over the second line of sacrificial layer of FIG. 18, thereby encapsulating the second line of sacrificial layer between the elastomeric structure of FIG. 14 and the third elastomeric layer.

FIG. 20 corresponds to FIG. 19, but shows the third elastomeric layer cured so as to be bonded to the monolithic structure composed of the previously bonded first and second elastomer layers.

FIG. 21 corresponds to FIG. 20, but shows the first and second lines of sacrificial layer removed so as to provide two perpendicular overlapping, but not intersecting, flow channels passing through the integrated elastomeric structure.

FIG. 22 is an illustration showing the system of FIG. 21, but with the planar substrate thereunder removed.

FIGS. 23a and 23b illustrates valve opening vs. applied pressure for various flow channel dimensions.

FIG. 24A is a top schematic view of an on/off valve.

FIG. 24B is a sectional elevation view along line 23B-23B in FIG. 24A

FIG. 25A is a top schematic view of a peristaltic pumping system.

FIG. 25B is a sectional elevation view along line 24B-24B in FIG. 25A

FIG. 26 is a graph showing experimentally achieved pumping rates vs. frequency for an embodiment of the peristaltic pumping system of FIGS. 25A and 25B.

### DETAILED DESCRIPTION OF THE INVENTION

Definitions

“Sample solution” refers to a solution comprising a mixture of two or more compounds, excluding the solvent.

“Separation” of an analyte from a sample solution refers to a process for separating a mixture of two or more different compounds such that the ratio of each compounds in a separated solution is different from the ratio of each compounds in the original, i.e., non-separated, solution.

As used herein the term “compound” can include a neutral molecules, ions, or combinations thereof.

“Microfabricated” refers to the size features of the flow channel of the microfluidic device of the present invention. In particular, the microfabricated channel is controlled to the micron level, with at least one dimension being microscopic (i.e., below 1000 μm, preferably below 500 μm, more preferably below 250 μm, and most preferably about 100 μm or less). Microfabrication typically involves semiconductor or MEMS fabrication techniques such as photolithography and spincoating that are designed for to produce feature dimensions on the microscopic level, with at least some of the dimension of the microfabricated structure requiring a microscope to reasonably resolve/image the structure.

“Chromatography” refers to the separation of a mixture of tow or more different compounds by distribution between two phases, one of which is stationary and one of which is moving. Various types of chromatography are possible, depending on the nature of the two phases involved: solid-liquid, liquid-liquid, gas-liquid, and gas-solid. Preferred chromatography of the present invention is solid-liquid, gas-solid, or combinations thereof. More preferred chromatography of the present invention is solid-liquid chromatography (i.e., liquid chromatography or LC).

“Distribution equilibrium” refers to the ratio of the amount of a substrate bound, i.e., adhered, to the stationary phase of the column or the flow channel and the amount of the substrate dissolved in the solution.

“Rotary” refers to a configuration of a channel which allows circulation of a fluid within a confined region or section of the channel. Such configuration can be a polygon, such as rectangle, hexagon, octagon, and the like; or, preferably, an ellipse or a circle.

The present invention is generally directed to devices and methods for use in performing separation of a particular analyte in a sample solution (i.e., a sample separation).

These methods and devices can be integrated with other microfluidic operations and/or systems, to perform a number of different manipulations, wherein the sample separation carried out within the context of the microfluidic device or system, is just one part of the overall operation. Examples of other microfluidic operations include chemical synthesis, protein synthesis, protein degradation, oligonucleotide synthesis (including PCR), nucleotide degradation, combinatorial synthesis, and the like.

The present invention will be described with regard to the accompanying drawings which assist in illustrating various features of the invention. In this regard, the present invention generally relates to microfluidic devices for separating an analyte from a sample solution, methods for producing the same, and methods for using the same. That is, the invention relates to microfluidic chromatography devices.

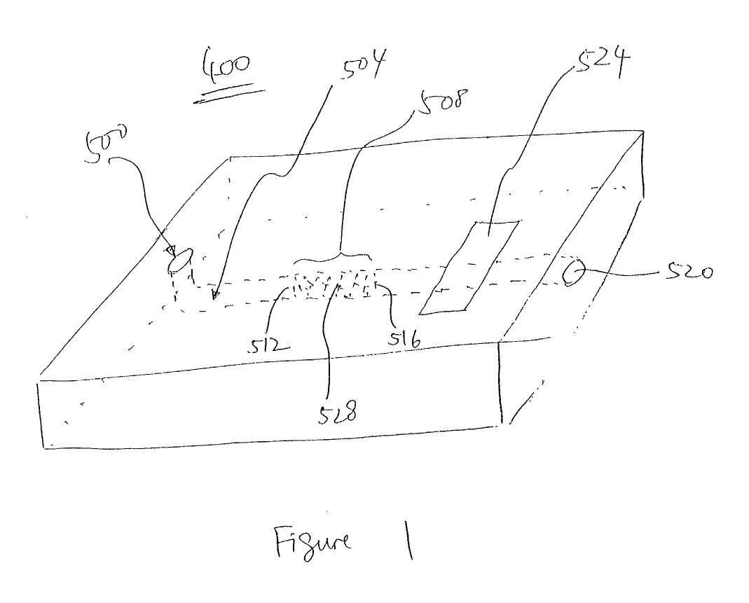

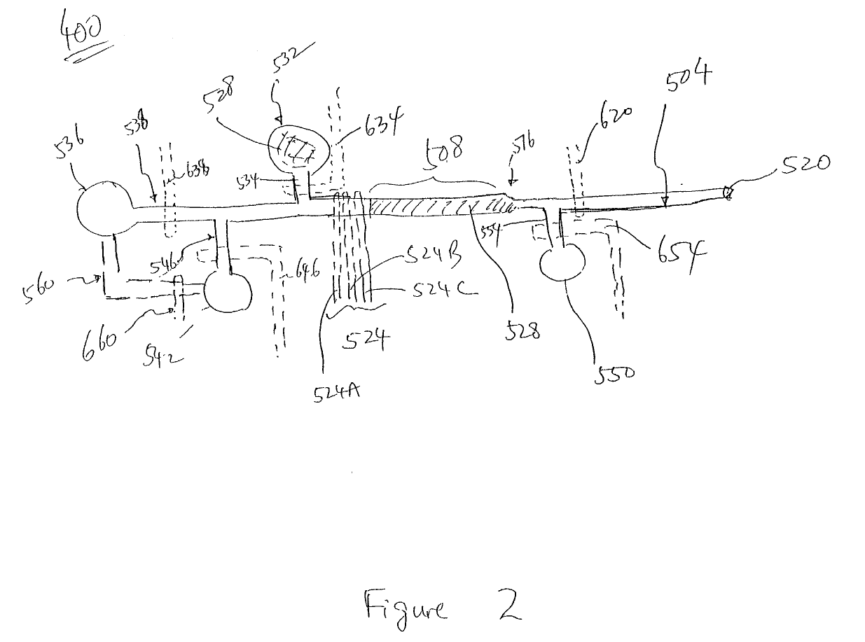

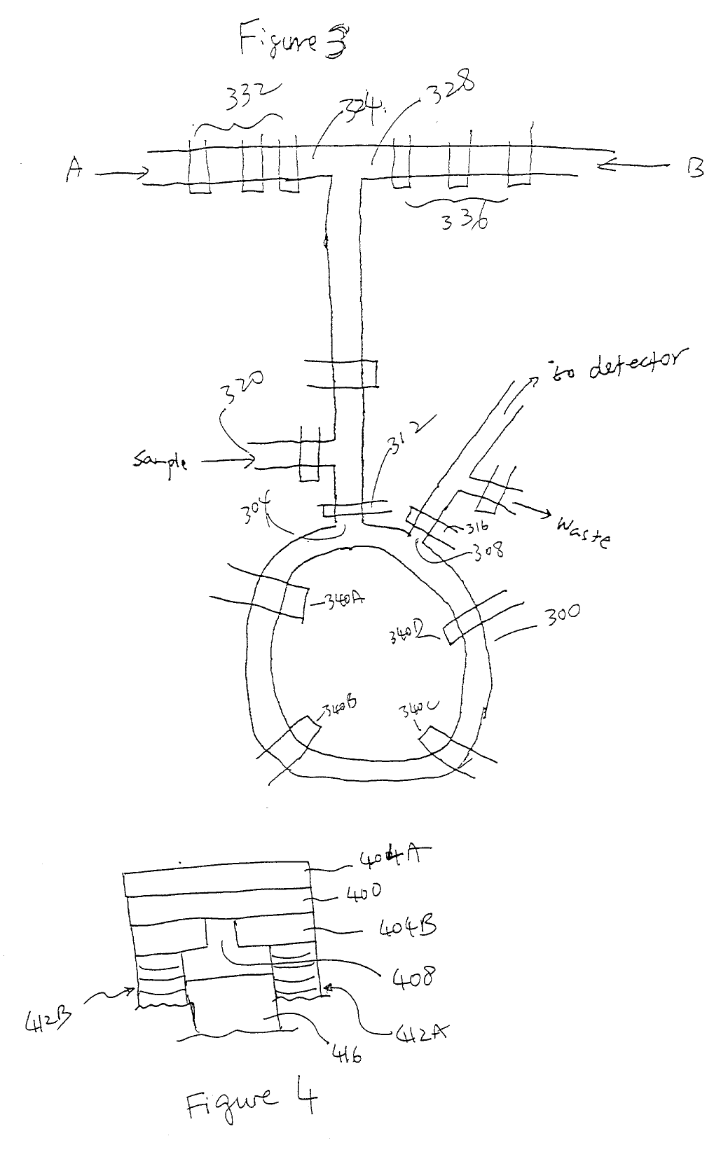

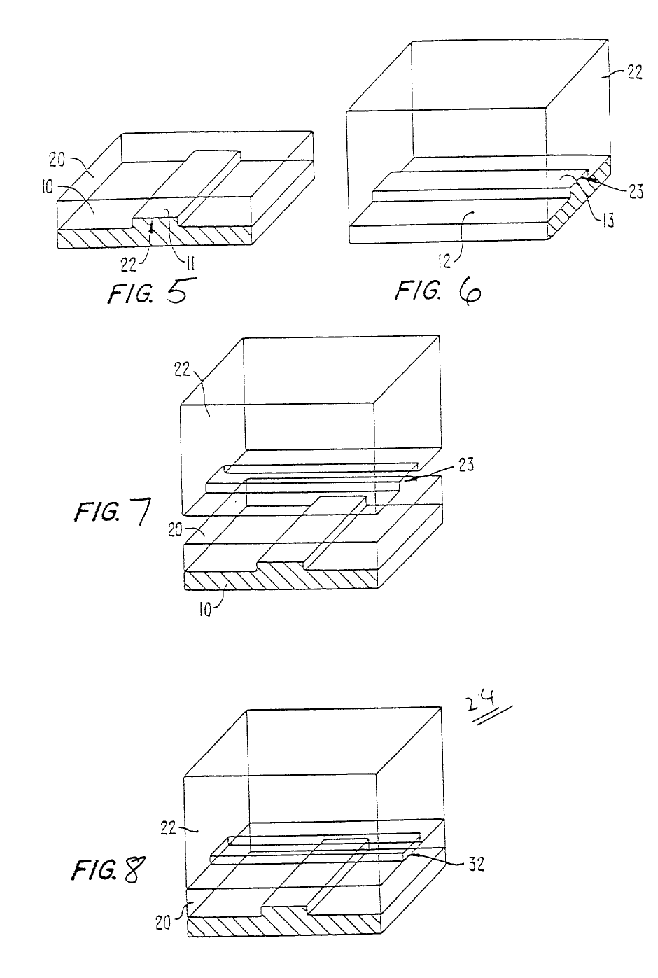

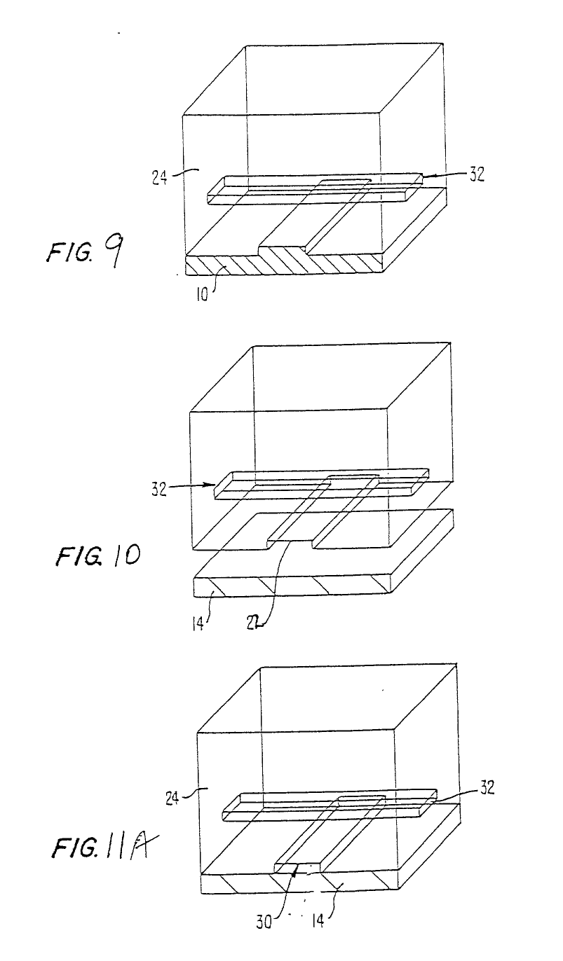

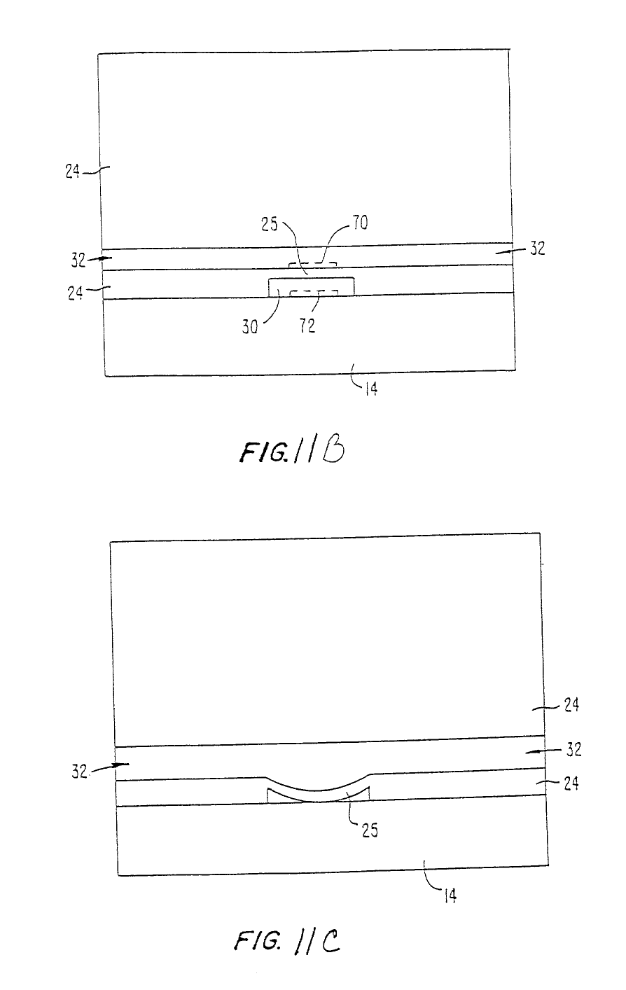

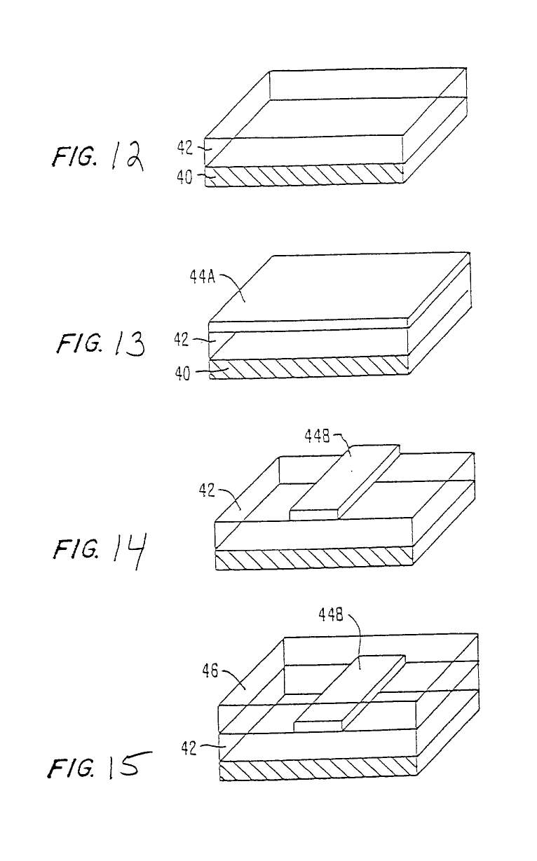

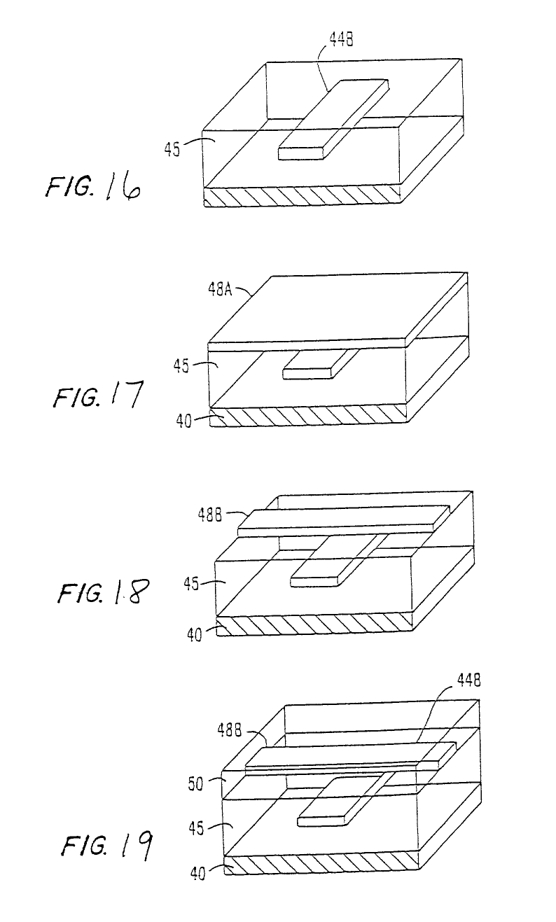

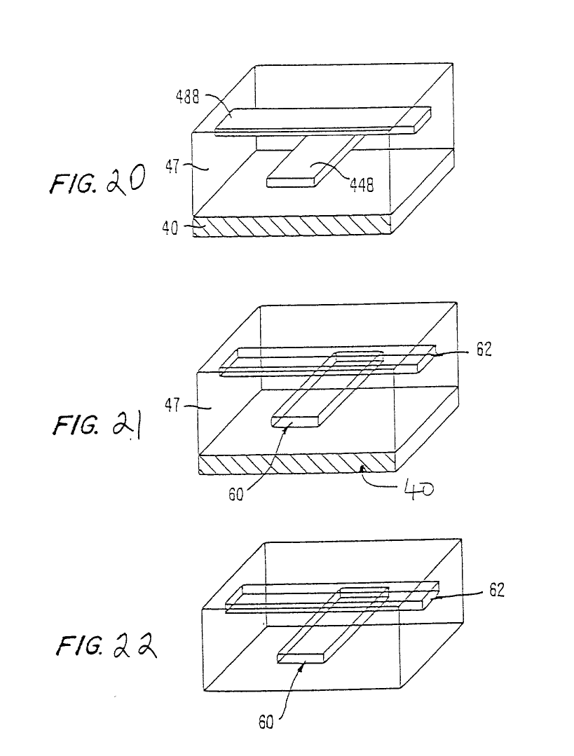

Two embodiments of microfluidic chromatography devices are generally illustrated in FIGS. 1 and 2, which are provided for the purposes of illustrating the practice of the present invention and which do not constitute limitations on the scope thereof.

Referring to FIG. 1, in one embodiment, the microfluidic device 400 of the present invention comprises an sample inlet port 500 for introducing the sample into the microfluidic device; a microfabricated flow channel 504 (shown in phantom in FIG. 1) downstream from and in fluid communication with the sample inlet port 500, wherein the flow channel 504 comprises a chromatography column portion 508 (shown in phantom in FIG. 1) having a proximal end 512 and a distal end 516 relative to the sample inlet port 500; a sample outlet port 520 downstream from and in fluid communication with the flow channel 504 for removing a separated sample from the flow channel 504; a material delivery system 524 for transporting a material through the flow channel 504; and a solid stationary phase 528 within the chromatography column portion 508, wherein the solid stationary phase 528 is capable of separating at least a portion of the analyte from the sample solution.

The material delivery system 524 can be any device that can transport a material (e.g., solid, liquid, or gas) through the flow channel 504, preferably at a precise flow rate. While FIG. 1 illustrates the material delivery system 524 as being downstream from the chromatography column portion 508, it should be appreciated that it can be located upstream from the chromatography column portion 508, or outside the microfluidic device 400. Exemplary material delivery systems which are useful in the present invention include capillary electrophoresis, syringe pumps (externally located relative to the microfluidic device 400), and a peristaltic pump such as those described by Unger et al. in Science 2000, 288, 113-116, and U.S. patent application Ser. No. 09/605,520, filed Jun. 27, 2000, which are incorporated herein by reference in their entirety. Preferably, the material delivery system comprises a peristaltic pump which comprises a plurality of control channels located within the microfluidic device 400 that are separated from the flow channel 504 by deflectable elastomeric segment. Such a peristaltic pump is discussed in more detail below. Briefly, the control channels of the peristaltic pump are individually addressable and are activated in sequence such that peristaltic pumping is achieved. Use of this peristaltic pump allows the material delivery system of the present invention to achieve a flow rate of 10 μL/min or less, preferably 10 μL/min or less, and more preferably 0.1 μL/min or less.

Referring again to FIG. 1, the solid stationary phase 528 is introduced through the sample inlet port 500 using the material delivery system 524 and are placed in the chromatography column portion 508 of the flow channel 504. By tapering the distal end 516 of the chromatography column portion 508, one can prevent the solid stationary phase 528 from leaking out of the chromatography column portion 508. Alternatively, a control channel (not shown) can be placed on top of the distal end 516 of the chromatography column 508 and actuated to deflect the elastomeric segment (not shown) down into the flow channel 504, thereby reducing the cross-sectional area. By controlling the amount of the elastomeric segment deflection, one can prevent the solid stationary phase 528 from leaking out of the chromatography column portion 508.

After the chromatography column portion 508 has been packed with an appropriate solid stationary phase 528, a sample solution containing the analyte to be separated is introduced into the flow channel 504 using the material delivery system 524 through the sample inlet port 500. Optionally, the column portion 508 can be flushed with an eluent prior to loading the column portion 508 with the sample solution. After the sample solution has been added, an appropriate eluent is then continuously added through the sample inlet port 500 using the material delivery system 524. As the sample solution is eluded with the eluent through the chromatography column portion 508, separation of the analyte is achieved. This separated analyte can be analyzed directly by having the outlet port 520 operatively interconnected to a detector. Alternatively, the separated analyte can be collected or used in subsequent steps by incorporating other sample manipulation systems within the microfluidic device 400, e.g., chemical synthesis system, polymerase chain reaction (PCR) system, peptide or nucleotide modification system such as degradation system or tagging system, and the like.

FIG. 2 shows a schematic illustration of the flow channel 504 and other components which may be present in the microfluidic chromatography device 400 of the present invention. Throughout this disclosure, when a reference is made to a control valve or a control system, it is meant that the control system is separated from the corresponding inlet or the channel by a deflectable elastomeric segment such that when the control system (i.e., channel) is actuated, the elastomeric segment deflects into the corresponding inlet or the channel thereby causing the inlet or the channel to close. In FIG. 2, in addition to the components in FIG. 1, the microfluidic chromatography device 400 can optionally further comprise a solid stationary phase reservoir 532, a solid stationary phase inlet channel 534, and a solid stationary phase inlet control system 634. In addition, the microfluidic device 400 can optionally comprise an eluent reservoir 536, an eluent inlet channel 538, and an eluent inlet channel control system 638. Furthermore, the microfluidic device 400 can optionally comprise a sample reservoir 542, a sample inlet channel 546, and a sample inlet control system 646. Moreover, the microfluidic device 400 can optionally comprise an excess solid stationary phase outlet 550, an excess solid stationary phase outlet channel 554, and an excess solid stationary phase outlet control system 654.

Referring again to FIG. 2, the solid stationary phase 528 is introduced into the chromatography column portion 508 from the solid stationary phase reservoir 532 using the material delivery system 524 which comprises a plurality of control channels 524A, 524B, and 524B which are individually addressable. These control channels are activated in sequence such that peristaltic pumping is achieved and causes the solid stationary phase to flow from the reservoir 532 into the column 508. The selective flow of solid stationary phase can be achieved by closing the eluent inlet channel 536 and the sample inlet channel 546 by actuating the eluent inlet control system 636 and the sample inlet control system 646, respectively, and opening the solid stationary phase inlet channel 534. Any excess solid stationary phase can be diverted to the excess solid stationary phase outlet 550 by closing the sample outlet port 520 by actuating the sample outlet control system 620 and opening the excess solid stationary phase outlet control 654. This prevents excess solid stationary phase from flowing into, for example, a detector which may be interconnected to the sample outlet port 520. As discussed above in reference to FIG. 1, the distal end 516 of the column portion 508 can be tapered to cause the solid stationary phase to plug the flow channel 504 and prevent leakage of the solid stationary phase out of the column portion 508. Alternatively, as described above, a control channel (not shown) can be placed on top of the distal end 516 of the chromatography column 508. In this manner, actuation of the control channel causes the elastomeric segment (not shown) to deflect down into the flow channel 504 and reduces the cross-sectional area. By controlling the amount of the elastomeric segment deflection, one can prevent the solid stationary phase 528 from leaking out of the chromatography column portion 508.

After the solid stationary phase 528 has been packed into the column portion 508, the column can be optionally flushed with the eluent prior to loading the column with the sample solution. To flush the column with the eluent, the solid stationary phase inlet channel 534 and the sample inlet channel 546 are closed by actuating the their respective control systems 634 and 646, and the eluent inlet channel 538 is opened by deactivating, i.e., relaxing, the eluent inlet channel control system 638. The eluent is then allowed to flow through the column portion 508 using the peristaltic pump 524. The excess eluent can be removed through the excess solid stationary phase outlet 550 or it can be allowed to flow out of the sample outlet port 520. The direction of the material flowing out of the column portion 508 can be controlled by selectively actuating the excess solid stationary phase outlet control 654 or the sample outlet control 620.

The sample solution is then loaded onto the column 508 by closing the eluent inlet 538 and the solid stationary phase inlet 534 by actuating their respective control systems 638 and 634, and opening the sample inlet 546. The sample is loaded onto the column using the peristaltic pump 524. The sample solution reservoir can optionally rinsed with the eluent by allowing the eluent to flow through an optionally present sample elution channel 560 (dashed line) by deactivating the sample elution control system 660 and closing the elution inlet 538 by actuating the control system 638. After the sample solution has been loaded onto the column 508, it can be eluted with the eluent by closing the sample inlet channel 546 and the solid stationary phase inlet 534 and opening the eluent inlet 538.

In this manner, at least a portion of the analyte in the sample solution can be separated via chromatography. By selecting an appropriate solid stationary phase and the eluent, one can separate the analyte based on a variety of physical properties. For example, the analyte can be separated based on its mobility by using a capillary electorphoresis process. Alternatively, one can separate the analyte based on its size by using a porous solid stationary phase in which the analyte or compounds smaller than the analyte can pass through the pores but the larger compounds are prevented from passing through the column 508. Such porous solid stationary phase are well known to one skilled in the art.

In addition, the analyte can be separated based on its affinity to the solid stationary phase and/or its solubility to the eluent. Such process is generally known as solid-liquid (or simply liquid) chromatography. The liquid chromatography process is based on differential solubilities (or absorptivities) of the analyte to be separated relative to the two phases (i.e., solid stationary phase and the liquid eluent) between which they are to be partitioned. Many different varieties of solid phase binders can be employed in the methods of the present invention to enable separation of an analyte from a solution. The term “solid phase” as used herein refers to any solid phase material that is capable of binding an analyte present in a liquid solution and does not dissolve in the eluent. Such solid stationary phase are well known to one skilled in the art and include, but are not limited to, silicates, talc, Fuller's earth, glass wool, charcoal, activated charcoal, celite, silica gel, alumina, paper, cellulose, starch, magnesium silicate, calcium sulfate, silicic acid, florisil, magnesium oxide, polystyrene, p-aminobenzyl cellulose, polytetrafluoroethylene resin, polystyrene resin, Sephadex®, copolymer of dextran, enzacryl®, Sepharose®, glass beads (e.g., controlled-pores glass), Agarose and other solid resins known to one skilled in the art, and combinations of two or more of the foregoing. For example, a mixture of celite and charcoal may be used as the adsorbent particles in the solid phase binders of the present invention. The solid phase can be shape, including pellets, granules, tablets, spheres, and the like. The side of solid phase should be small enough to be contained within the flow channel of the microfluidic device.

Types of Solid Phases

Entrapped/Attached Adsorbent Particle

In one embodiment, the solid phase employed in the methods of the present invention includes an adsorbent particle or particles attached to or entrapped in a matrix (including a polymer matrix). For example, the adsorbent particle or particles can be incorporated into a matrix (including a polymer matrix). As another example, the adsorbent particle or particles can be attached to a porous glass support such as a porous glass bead. Any of the solid phase materials described herein above can be used for the attachment or entrapment of the adsorbent particle.

Charcoal adsorbents (i.e., any solid phase adsorbent containing charcoal) are one preferred type of adsorbent particle for use in the methods of the present invention. The charcoal adsorbent particles can be particles of treated or untreated charcoal. Alternatively, the charcoal adsorbent can be particles of charcoal that are attached to a variety of different solid supports including the polymers and matrices described above.

The solid phase comprising an adsorbent particle attached to or entrapped in a matrix can be prepared using conventional techniques known to those skilled in the art. For example, charcoal can be entrapped in a polymer by adding charcoal to acrylamide during the production of polyacrylamide gel. Methods for attaching adsorbent particles to polymers or matrices such as glass beads are also known in the art.

When contacted with the analyte contained in the solution according to the methods of the present invention, the adsorbent particles entrapped in or attached to the matrix, form a complex with the analyte. The solid phase binds to the analyte in the solution, thereby facilitating the physical separation of the analyte from the bulk of the solution. The type of binding in the complex varies depending on the type of solid phase that is used and the nature of the analyte in the solution.

Magnetizable Solid Phase

Magnetizable solid phases are another type of solid phase binders which can be employed in the methods of the present invention to remove analytes from a solution. The term “magnetizable solid phase” refers to a solid phase material in any shape, including pellets, granules, tablets, spheres, and the like, which uses magnetizable material, imbedded, encapsuled, or otherwise incorporated within the solid phase, rendering the solid phase reactive to a magnetic field. There can be a variety of different types of magnetizable materials. These materials can use different magnetizable constituents as well as different matrices to form the solid phase particle. There are a variety of different magnetizable constituents that can be used in the particle. Typically, the magnetic constituents are not magnetized metals, but rather metallic constituents that can be attracted, or otherwise be reactive by the use of a magnetic field. However, particles with magnetic properties can also be used. Typical examples of magnetizable constituents include but are not limited to ferric oxide, nickel oxide, barium ferrite, and ferrous oxide. The magnetizable constituents are entrapped in or attached to a matrix. The matrix can be glass or a polymer matrix comprised of polyacrylamide, polyacrolein, cellulose, agarose, latex, nylon, polystyrene, and copolymers thereof.

Another variety of magnetizable solid phase includes an adsorbent particle(s), such as those described above entrapped within a magnetizable polymer. The term “magnetizable polymer,” as used herein refers to a polymer containing a magnetizable constituent. Polyacrylamide, polyacrolein, cellulose polymers, lagex agarose, nylon, polystyrene and copolymers thereof, which have incorporated iron oxide particles are examples of magnetizable polymers. A variety of magnetizable solid phases, their use and methods of their preparation are described in M. Pourfarzaneh, et al., Methods of Biochemical Analysis 28: 267 (1982), which is incorporated herein by reference in its entirety.

Magnetizable solid phases can use any of the binding principles used for other solid phases. For example, magnetizable solid phases can have adsorbent particles attached to or incorporated into a magnetizable particle or polymer. These particles can bind analytes by the process of adsorption.

Magnetizable solid phases can be prepared using methods known to those of skill in the art. For example, magnetizable polymers can be prepared as described in M. Pourfarzaneh (1980) “Synthesis of Magnetizable Solid Phase Supports for Antibodies and Antigens and Their Application to Isotopic and Non-isotopic Immunoassay,” Medical College of St. Bartholomew's Hospital, University of London, London, UK, which is incorporated herein by reference in its entirety. For example, iron oxide can be incorporated into a polyacrylamide or polyacrolein gel during the polymerization reaction. As another example, charcoal particles entrapped in a magnetizable polymer matrix can be prepared as described in M. Pourfarzaneh (1980) supra. A variety of other magnetizable polymers can also be prepared by similar methods or by other methods know to those of skill in the art.

When contacted with the analytes contained in the solution to be treated according to the methods of the present invention, the magnetizable solid phase forms a physical adsorption or biological reaction complex with the analyte. The magnetizable solid phase binds to the analytes in the solution. The particular type of binding in the complex varies depending on the type of magnetizable particle employed and the nature of the analytes in the solution.

Immunochemical Binders

Some analytes can be separated from solutions by use of solid phase immunochemical binders. The term “immunochemical binder” refers to those solid phases that use antibody-antigen binding to accomplish the binding of an analyte to a solid phase. The term also includes the binding of antibodies in solutions by non-immunoglobulin proteins such as protein A, protein G, combined protein A-protein G molecules (protein A/G). Immunochemical binders generally include an antibody, plantibody, natural or synthetic binder, or a genetically engineered antibodies or binders specific for an analyte bound or coupled to a solid support such as the matrices (including polymer matrices) or magnetizable polymers or solid phases described herein above.

The term “antibody” as used herein refers to an immunoglobulin molecule capable of binding to a specific epitope on an antigen. Antibodies can be a polyclonal mixture or monoclonal. Antibodies can be intact immunoglobulins derived from natural sources or from recombinant sources and can be immunoreactive portions of intact immunoglobulins. Antibodies are typically immunoglobulin polypeptide chains. The antibodies can exist in a variety of forms including for example, Fv, F_{ab}, and F_{(ab)2}, as well as in single chains (See, e.g., Huston, et al., Proc. Nat. Acad. Sci. U.S.A. 85: 5879 (1988) and Bird, et al., Science 242: 423 (1988), the disclosures of which are incorporated herein by reference in their entirety). See generally, Hood, et al., IMMUNOLOGY, Benjamin, N.Y., 2nd ed. (1984), and Hunkapiller and Hood, Nature 323: 15 (1986), the disclosures of which are incorporated herein by reference in their entirety.

The term “plantibody” as used herein refers to an immunoglobulin molecule, derived from a plant, which is capable of binding to a specific epitope of an antigen. Generally, plantibodies are recombinant proteins including antibodies, which are expressed in plants. Plantibodies are known in the art, as described in Institut fur Biologie I, Antibody Engineering Group, Rheinisch-Westfalische Technische Hochschule Aachen (1997).

Genetically engineered antibodies can also be used in the immunochemical binders of the present invention. An example of genetically engineered antibodies include genetically engineered chimeric monoclonal antibodies in which the hypervariable region of a mouse monoclonal antibody, which contains the antigen recognition site, is incorporated into a human immunoglobulin. See, Colcher et al., Cancer Research 49: 1738 (1989). Conventional techniques for producing genetically engineered antibodies can also be employed to produce antibody fragments. See, Morrison and Oi, Adv. Immunol. 44: 65 (1990) and Rodwell, Nature 342: 99 (1989). These genetically engineered antibody fragments can also be employed in the immunochemical binders of the present invention.

The immunochemical binders can also comprise an antibody and a solid phase particle attached to or entrapped in a matrix (including a polymer matrix). Typically, a solid phase immunochemical binder has an antibody capable of binding an analyte coupled to a solid phase in the solution. The antibody can be a naturally occurring or synthetically produced binder, or a plantibody, or a genetically engineered binder specific for a particular organic molecule. The immunochemical binders can also comprise an antibody attached to a magnetizable polymer particle such as the magnetizable polymers described above.

Alternatively, an antigen can be coupled to a solid phase and used to bind antibodies that are present in the solution. For example, antibodies that bind analytes can be added to a solution to form an immunocomplex with the analyte. The immunocomplex can be bound by a solid phase capable of binding the liquid phase antibody. Examples of such solid phase include anti-immunoglobulin antibodies, protein A, protein G, or protein A/G coupled to a solid phase adsorbent particle.

Methods of preparing solid phase immunochemical binders are well known to those of skill in the art. For example, antibodies can be attached to various solid phases by methods used for constructing immunoassay solid supports. See, ENZYME IMMUNOASSAY, E. T. Maggio, ed., CRC Press, Boca Raton, Fla. (1980); “Practice and Theory of Enzyme Immunoassays,” P. Tijssen, LABORATORY TECHNIQUES IN BIOCHEMISTRY AND MOLECULAR BIOLOGY, Elsevier Science Publishers B. V. Amsterdam (1985); and Harlow and Lane, ANTIBODIES: A LABORATORY MANUAL, Cold Spring Harbor Pubs., N.Y. (1988), each of which is incorporated herein by reference in their entirety.

Immunochemical binders including magnetizable particle immunochemical binders can be prepared as described in M. Pourfarzaneh, et al., (1980) supra. Antibodies and other proteins and peptides of interest can be coupled to a variety of magnetizable polymer solid supports using methods known in the art. For example, antibodies and other proteins can be coupled to CNBr-activated magnetizable cellulose and to glutaraldehyde activated magnetizable polyacrylamide using standard procedures. See, M. Pourfarzaneh, et al., (1980) supra. In addition, polymers such as polyacrolein have highly reactive aldehyde groups on their surface which can be coupled to primary amino groups of proteins. See, M. Pourfarzaneh, et al., (1980) supra. A number of other polymer and protein chemistry reactions known to those of skill in the art can also be used to couple antibodies and other proteins to the magnetizable polymers to produce the solid phase binders of the present invention.

The immunochemical binders form a complex with the analytes contained in the solution when the binders are contacted with the solution. Typically, the immunochemical binder binds to the analytes in the solution by antigen-antibody binding in the formation of the complex.

Natural Protein Conjugate Binder

Another example of solid phase which can be used in the methods of the present invention includes natural protein conjugate binders. Natural protein conjugate binders generally comprise a natural protein such as polymyxin (i.e., polymyxin A, B, C, D, E, F, K, M, P, S, or T) or a mixture of polymyxins attached to a solid phase particles. Another natural protein for natural protein conjugate binders is thyroxin binding globulin which is a natural carrier binder for thyroxin hormone. This natural carrier protein binder is also capable of binding to furosemide, a carcinogenic and tertatogenic agent and 8-analino-1-naphthalene sulfonic acid, a known carcinogenic agent. The solid phase particles can be any of those described above, including solid phase magnetizable particles.

The polymyxins which can be conjugated to the solid phase are antibiotic complexes produced by Bacillus polymyxa. See, Brownlee, Biochem. J 43: XXV (1948). Methods for conjugating or attaching these natural proteins to a solid support are known in the art and conjugates of polymyxins on other types of common solid supports are commercially available. For example, the AFFI-PREP® polymyxin support is available from Bio-Rad Laboratories. Polymyxin conjugate solid phase binders are particularly useful for separating endotoxins from solutions. Endotoxins are pyrogenic lipopolysaccharides of gram-negative bacteria which are common contaminants of aqueous and physiological solutions.

Typically, the natural protein conjugate binder binds to the organic molecules in the solution by mechanisms similar to antigen-antibody binding in the formation of the complex.

Targeted Peptide Binders

Yet another type of solid phase which can be used in the methods of the present invention is a targeted peptide binders. Targeted peptide binders typically comprise a peptide attached to a solid phase described herein above. The peptide attached to the solid phase binds to a specific analyte, and is thus “targeted” toward separating that analyte from the solution. The particular analyte which binds to a given targeted peptide binder depends on the peptide employed. When the analyte(s) to be separated from the solution is known, a peptide binder can be designed with a peptide which can specifically and tightly bind that analyte(s). An example of a targeted peptide binder is hepatitis B surface antigen fragments known as Tre-S 1[12-32] or Tre-S2[1-32] or Tre-S2[1-26], which can be synthesized and attached to solid phase particles, and used as a binder to separate antibodies to hepatitis B surface antigen. Similarly, peptides can be synthesized for hepatitis C and hepatitis A virus and other infectious agents. The peptide binders can be prepared using the general techniques known in the art for attaching a peptide to a solid support. Examples of such techniques include conventional peptide synthesizers.

Oligonucleotide Binders

Another category of solid phases which can be used in methods of the present invention are oligonucleotide binders. Oligonucleotide binders include synthetic oligonucleotide binders and targeted oligonucleotide binders. Generally, oligonucleotide binders including an oligonucleotide attached to a to a solid phase described herein above.

In the case of synthetic oligonucleotide binders, the oligonucleotide attached to the solid phase is a synthetic oligonucleotide which may or may not be targeted toward a specific analyte. For example, a synthetic oligonucleotide binder including a synthetic oligonucleotide which binds to multiple nucleotide molecules. Typically, the synthetic oligonucleotide binders are specific to one or a few particular analytes. Many different synthetic oligonucleotides are known in the art, and any such synthetic oligonucleotides can be attached to the solid phase to produce the oligonucleotide binders.

As an example, oligodeoxythymidylic acid (oligo dt) is one synthetic oligonucleotide which can be attached to any of the solid phase discussed above. Synthetic oligonucleotide binders comprising oligo dt are useful for removing, for example, hepatitis iruses from solutions.

In the case of targeted oligonucleotide binders, the oligonucleotide attached to the solid phase binds to a specific analyte, and is thus “targeted” toward the separation of that analyte from the solution. The particular analyte which binds to a given targeted oligonucleotide binder depends on the oligonucleotide employed. When the analyte(s) to be separated from the solution is known, an oligonucleotide binder can be designed with an oligonucleotide which will specifically and tightly bind that analyte(s).

In one preferred embodiment, the targeted oligonucleotide binder is a targeted RNA binder. Targeted RNA binders can be designed as complementary to a known analyte in the solution.

One specific example of a targeted oligonucleotide binder is an aptamer attached to a solid phase described above. Aptamers are single stranded RNA or DNA oligonucleotides that recognize and bind to specific analytes. See, K. O'Rourke, Clinical Laboratory News Nov.: 1 (1997). Oligonucleotide binders including aptamers attached to a solid phase can be useful for separating analytes such as specific proteins from solutions.

The oligonucleotide binders can be prepared using the general techniques known in the art for attaching an oligonucleotide to a solid support.

Rotary Pump Configuration

The results of chromatographic separation depend on many factors including, but not limited to, the solid phase chosen, polarity of the solvent, size of the column (both length and diameter) relative to the amount of material to be chromatographed, and the rate of elution. Columns shown in FIGS. 1 and 2 are single pass columns, i.e., samples and solutions travel through the column only once during operation. Thus, in some cases a long column or multiple columns arranged in series may be required to separate the sample effectively. This is particularly true when the sample has a relatively low distribution equilibrium between the solid phase and the solvent. In other cases, the sample can bind tightly to the solid phase and may require a different solvent to elute the sample from the solid phase. For example, proteins/peptides with molecular weight of greater than 1000 in aqueous medium bind tightly to C-18 alkyl solid phase. This bonding is so strong that it is difficult to effectively remove the protein from the solid phase using water. Typically an organic eluent, such as acetonitrile, alchohol (e.g., methanol, ethanol, or isopropanol), other relatively polar organic solvents (e.g., DMF), or mixtures thereof, is used as an eluent to remove the protein from the solid phase.

In one particular embodiment, it has been found that this difference in the distribution equilibrium of samples, e.g., proteins, in different solvents can be used advantageously with microfluidic devices of the present invention in some sample separations. One such configuration is illustrated in FIG. 3, which will now be described in reference to separating proteins. It should be appreciated, however, that other compounds having a similar distribution equilibrium difference in different solvents can be separated using the principle (i.e., affinity chromatography) disclosed herein. The microfluidic device of FIG. 3 comprises a rotary flow channel 300 which has an inlet 304 and an outlet 308. The solid phase (not shown) is located within the flow channel 300. For protein separation, the surface of the solid phase can comprise covalently bonded C-18 alkyl or other compound that binds strongly to proteins in aqueous solution. An aqueous protein solution is introduced into the rotary flow channel 300 by opening the control valves 312 and 316. If the volume of the sample is insufficient to completely fill the rotary flow channel 300, additional water can be added through the inlet 304. Water can be introduced through the same sample port 320 or, as shown in FIG. 3, a separate solvent port 324 can be present in the microfluidic devices. Optionally, the microfluidic devices can further comprise an additional solvent port 328 for introducing a second solvent which can be mixed with the first solvent that is introduced through the solvent port 324. Preferably, each solvent port has its own pump and control valve systems 332 and 336.

After the rotary flow channel 300 is filled with the aqueous protein solution, control valves 312 and 316 are actuated to maintain a closed system. The aqueous protein solution is then circulated through the rotary flow channel using a pump comprised of control valves 340A-340D until substantially all the high molecular proteins are bound to the solid phase located within the flow channel 300. The rotary flow channel 300 can be flushed with water by opening the control valves 312 and 316 and introducing additional water through the inlet 304 and removing the solution through the outlet 308. The exiting solution can be connected to other rotary flow channel(s) (not shown) to further separate other compounds that may be present, discarded, collected, or sent to a detector system to identify the contents of the exiting solution. At this stage, high molecular proteins are bound to the solid phase located within the rotary flow channel 300 and low molecular proteins and other polar compounds have been removed from the rotary flow channel 300. To recover the solid support bound protein, acetonitrile, methanol, ethanol or mixtures thereof, or an aqueous mixture of such solvent is introduced to the rotary flow channel 300 through the inlet 312. Presence of organic solvent lowers the distribution equilibrium between the solid phase and the solvent, i.e., the amount of protein in the solution is increased. The organic solution containing dissolved proteins can be collected, analyzed, or further manipulated as needed. Alternatively, after introducing the organic solvent, control valves 312 and 316 can be closed and the solvent circulated through the rotary fluid channel 300 prior to removing the solution from the rotary fluid channel 300. This allows dissolution of proteins in a small volume of the organic solvent.

Pressure Plates

In some embodiments, a relatively high pressure is required to move the fluids through the microfluidic device. In these instances the integrity of the microfluidic device can be compromised, especially if the microfluidic device is fabricated using a multilayer construction and/or comprises an elastomer. In order to maintain the integrity of the microfluidic device during a high pressure sample separation, one can provide a pressure plate as illustrated in FIG. 4. The microfluidic device 400 is placed between two pressure plates 404A and 404B. The pressure plates can be any solid material that can withstand the applied pressure and provide structural integrity of the microfluidic device 400. For example, the pressure plate can be fabricated from wood, metal, and the like. The pressure plate 404B can comprise an opening 408 which allows introduction of samples, fluids, and pressure to the flow channel. The pressure plate can further comprise threads 412A and 412B. Preferably, the threads 412A and 412B are interconnected to the pressure plate 404A such that when a pressure applicator (e.g., a screw) 416 is threaded into the threads 412A and 412B, it contacts the pressure plate 404B and pushes the pressure plate 404B towards the pressure plate 404A. In this manner, when a high pressure is applied to the flow channel of the microfluidic device 400, the polymer's structural integrity is maintained by the pressure plates.

Basic Features of the Microfluidic Devices

In one particular aspect of the present invention, the microfluidic devices comprise a microfabricated flow channel. The microfluidic devices can optionally further comprise a variety of plumbing components (e.g., pumps, valves, and connecting channels) for flowing materials such as an eluents, solid stationary phases, and sample solutions. Optionally, the microfluidic devices can also comprise an array of reservoirs for storing eluents, samples, solid stationary phases, and other reagents, each of which can be stored in a different reservoir.

The microfluidic devices of the present invention have a basic “flow channel” structure. The terms “microfabricated flow channel,” “flow channel,” “fluid channel,” and “flow channel” are used interchangeably herein and refer to recess in a microfluidic device in which a fluid, such as gas or, preferably, liquid, can flow through. As described in detail below, the flow channels can be actuated to function as the plumbing components (e.g., micro-pumps, micro-valves, or connecting channels) of the microfluidic devices.

In one embodiment, microfabricated flow channels are cast on a chip (e.g., a elastomeric chip). Fluid channels are formed by bonding the chip to a flat substrate (e.g., a glass cover slip or another polymer) which seals the channel. Thus, one side of the fluid channel is provided by the flat substrate.

The plumbing components can be microfabricated as described below. For example, the microfluidic devices can contain an integrated flow cell in which a plurality of fluid channels are present. In addition microfluidic devices of the present invention can also include fluidic components (such as micro-pumps, micro-valves, and connecting channels) for controlling the flow of the materials, such as eluents, samples and solid stationary phases, into and out of the fluid channels. Alternatively, the microfluidic devices of the present invention can utilize other plumbing devices. See for example, Zdeblick et al., A Microminiature Electric-to-Fluidic Valve, Proceedings of the 4th International Conference on Solid State Transducers and Actuators, 1987; Shoji et al., Smallest Dead Volume Microvalves for Integrated Chemical Analyzing Systems, Proceedings of Transducers '91, San Francisco, 1991; and Vieider et al., A Pneumatically Actuated Micro Valve with a Silicon Rubber Membrane for Integration with Fluid Handling Systems, Proceedings of Transducers '95, Stockholm, 1995, all of which are incorporated herein by reference in their entirety.

As noted above, at least some of the components of the microfluidic devices are microfabricated. Employment of microfabricated fluid channels and/or microfabricated plumbing components significantly reduce the dead volume and decrease the amount of time needed to exchange reagents, which in turn increase the throughput. Microfabrication refers to feature dimensions on the micron level, with at least one dimension of the microfabricated structure being less than 1000 μm. In some microfluidic devices, only the fluid channels are microfabricated. In some microfluidic devices, in addition to the fluid channels, the valves, pumps, and connecting channels are also microfabricated. Unless otherwise specified, the discussion below of microfabrication is applicable to production of all microfabricated components of the microfluidic devices (e.g., the fluid channels, valves, pumps, and connecting channels).

Various materials can be used to produce the microfluidic devices. Preferably, elastomeric materials are used. Thus, in some microfluidic devices, the integrated (i.e., monolithic) microstructures are made out of various layers of elastomer bonded together. By bonding these various elastomeric layers together, the recesses extending along the various elastomeric layers form fluid channels through the resulting monolithic, integral elastomeric structure.

In general, the microfabricated structures (e.g., fluid channels, pumps, valves, and connecting channels) have widths of about 0.01 to 1000 microns, and a width-to-depth ratios of between 0.1:1 to 100:1. Preferably, the width is in the range of 10 to 200 microns, a width-to-depth ratio of 3:1 to 15:1.

Use of microfluidic devices of the present invention reduces the sample size and the amount of eluent needed as well as providing a sufficiently small fluid flow rate for microfluidic chromatography process.

Basic Methods of Microfabrication

Typically, the microfluidic devices of the present invention are fabricated from a material comprising a polymer, preferably an elastomeric polymer. Such microfluidic devices and methods for producing the same are disclosed in the above mentioned U.S. patent application Ser. No. 09/605,520, filed Jun. 27, 2000, and Science 2000, 288, 113-116, which have been incorporated herein by reference in their entirety.

Various methods can be used to produce the microfabricated components of the microfluidic devices of the present invention. Fabrication of the microchannels, such as flow channels, valves, and pumps, can be performed as described in the above mentioned Unger et al., Science 2000, 288, 113-116, and U.S. patent application Ser. No. 09/605,520, filed Jun. 27, 2000.

One particular method of producing microfluidic devices of the present invention is illustrated in FIGS. 5 to 11B. In this embodiment, pre-cured elastomer layers are assembled and bonded to produce a flow channel. As illustrated in FIG. 5, a first micromachined mold 10 is provided. Micro-machined mold 10 can be fabricated by a number of conventional silicon processing methods including, but not limited to, photolithography, plasma etching, ion-milling, and electron beam lithography. The micro-machined mold 10 has a raised line or protrusion 11 extending therealong. A first elastomeric layer 20 is cast on top of mold 10 such that a first recess 22 can be formed in the bottom surface of elastomeric layer 20, (recess 22 corresponding in dimension to protrusion 11), as shown.

As can be seen in FIG. 6, a second micro-machined mold 12 having a raised protrusion 13 extending therealong is also provided. A second elastomeric layer 22 is cast on top of mold 12, as shown, such that a recess 23 can be formed in its bottom surface corresponding to the dimensions of protrusion 13.

As can be seen in the sequential steps illustrated in FIGS. 7 and 8, second elastomeric layer 22 is then removed from mold 12 and placed on top of first elastomeric layer 20. As can be seen, recess 23 extending along the bottom surface of second elastomeric layer 22 forms a flow channel 32.

Referring to FIG. 7, the separate first and second elastomeric layers 20 and 22 (FIG. 8) are then bonded together to form an integrated (i.e., monolithic) elastomeric structure 24.

As can been seen in the sequential step of FIGS. 9 through 11A, elastomeric structure 24 is then removed from mold 10 and positioned on top of a planar substrate 14. As can be seen in FIGS. 11A and 11B, when elastomeric structure 24 has been sealed at its bottom surface to planar substrate 14, recess 22 forms a flow channel 30.

The present elastomeric structures can form a reversible hermetic seal with nearly any smooth planar substrate. An advantage to forming a seal this way is that the elastomeric structures can be peeled up, washed, and re-used. In some microfluidic devices, planar substrate 14 is glass. A further advantage of using glass is that glass is transparent, allowing optical interrogation of elastomer channels and reservoirs. Alternatively, the elastomeric structure can be bonded onto a flat elastomer layer by the same method as described above, forming a permanent and high-strength bond. This can prove advantageous when higher back pressures are used.

In another embodiment of the present invention, microfabrication involves curing each layer of elastomer “in place” (FIGS. 12 to 22). In this method, fluid flow and control channels are defined by first patterning sacrificial layer on the surface of an elastomeric layer (or other substrate, which can include glass) leaving a raised line of sacrificial layer where a channel is desired. Next, a second layer of elastomer is added thereover and a second sacrificial layer is patterned on the second layer of elastomer leaving a raised line of sacrificial layer where a channel is desired. A third layer of elastomer is deposited thereover. Finally, the sacrificial layer is removed by dissolving it out of the elastomer with an appropriate solvent, with the voids formed by removal of the sacrificial layer becoming the flow channels passing through the substrate, i.e., microfluidic device.

Referring first to FIG. 12, a planar substrate 40 is provided. A first elastomeric layer 42 is then deposited and cured on top of planar substrate 40. Referring to FIG. 13, a first sacrificial layer 44A is then deposited over the top of elastomeric layer 42. Referring to FIG. 14, a portion of sacrificial layer 44A is removed such that only a first line of sacrificial layer 44B remains as shown. Referring to FIG. 15, a second elastomeric layer 46 is then deposited over the top of first elastomeric layer 42 and over the first line of sacrificial layer 44B as shown, thereby encasing first line of sacrificial layer 44B between first elastomeric layer 42 and second elastomeric layer 46. Referring to FIG. 16, elastomeric layers 46 is then cured on layer 42 to bond the layers together to form a monolithic elastomeric substrate 45.

Referring to FIG. 17, a second sacrificial layer 48A is then deposited over elastomeric structure 45. Referring to FIG. 18, a portion of second sacrificial layer 48A is removed, leaving only a second sacrificial layer 48B on top of elastomeric structure 45 as shown. Referring to FIG. 19, a third elastomeric layer 50 is then deposited over the top of elastomeric structure 45 and second sacrificial layer 48B as shown, thereby encasing the second line of sacrificial layer 48B between elastomeric structure 45 and third elastomeric layer 50.

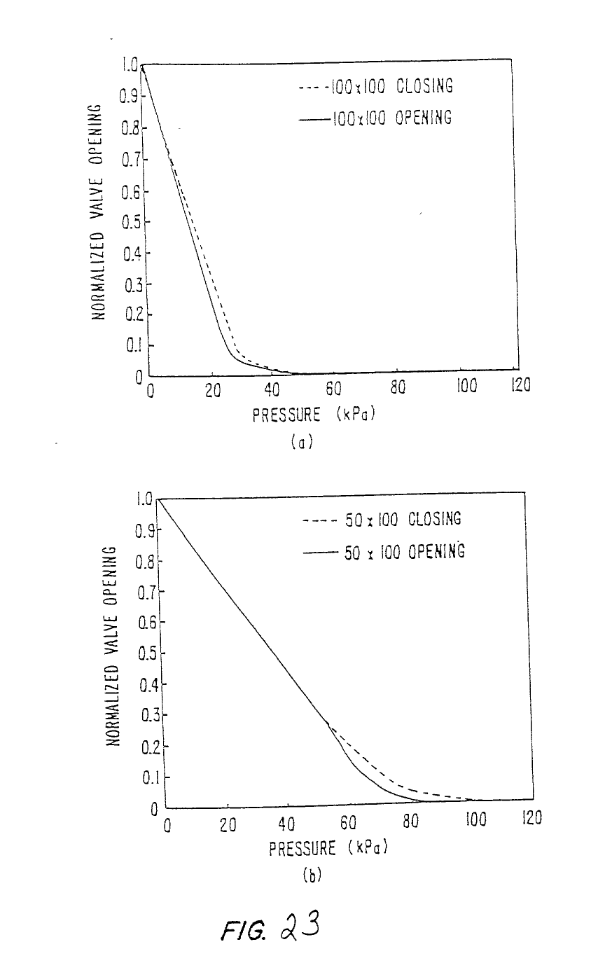

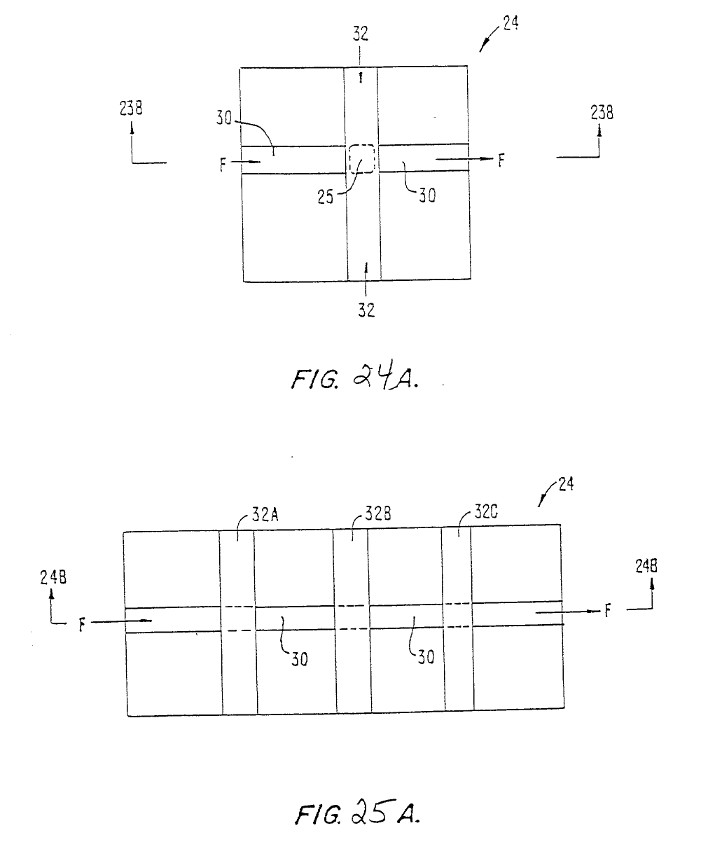

Referring to FIG. 20, third elastomeric layer 50 and elastomeric structure 45 are then bonded together forming a monolithic elastomeric structure 47 having sacrificial layers 44B and 48B passing therethrough as shown. Referring to FIG. 21, sacrificial layers 44B and 48B are then removed (for example, by dissolving in a solvent) such that a first flow channel 60 and a second flow channel 62 are provided in their place, passing through elastomeric structure 47 as shown. Lastly, referring to FIG. 22, planar substrate 40 can be removed from the bottom of the integrated monolithic structure.

Multilayer Construction

Soft lithographic bonding can be used to construct an integrated system which contains multiple flow channels. A heterogenous bonding can be used in which different layers are of different chemistries. For example, the bonding process used to bind respective elastomeric layers together can comprise bonding together two layers of RTV 615 silicone. RTV 615 silicone is a two-part addition-cure silicone rubber. Part A contains vinyl groups and catalyst; part B contains silane (Si-H) groups. The conventional ratio for RTV 615 is 10A:1B. For bonding, one layer can be made with 30A:1B (i.e., excess vinyl groups) and the other with 3A:1B (i.e., excess silane groups). Each layer is cured separately. When the two layers are brought into contact and heated at elevated temperature, they bond irreversibly forming a monolithic elastomeric substrate.

A homogenous bonding can also be used in which all layers are of the same chemistry. For example, elastomeric structures are formed utilizing Sylgard 182, 184 or 186, or aliphatic urethane diacrylates such as (but not limited to) Ebecryl 270 or Irr 245 from UCB Chemical. For example, two-layer elastomeric structures were fabricated from pure acrylated Urethane Ebe 270. A thin bottom layer was spin coated at 8000 rpm for 15 seconds at 170° C. The top and bottom layers were initially cured under ultraviolet light for 10 minutes under nitrogen utilizing a Model ELC 500 device manufactured by Electrolite corporation. The assembled layers were then cured for an additional 30 minutes. Reaction was catalyzed by a 0.5% vol/vol mixture of Irgacure 500 manufactured by Ciba-Geigy Chemicals. The resulting elastomeric material exhibited moderate elasticity and adhesion to glass.

In some applications, two-layer elastomeric structures were fabricated from a combination of 25% Ebe 270/50% Irr245/25% isopropyl alcohol for a thin bottom layer, and pure acrylated Urethane Ebe 270 as a top layer. The thin bottom layer was initially cured for 5 min, and the top layer initially cured for 10 minutes, under ultraviolet light under nitrogen utilizing a Model ELC 500 device manufactured by Electrolite corporation. The assembled layers were then cured for an additional 30 minutes. Reaction was catalyzed by a 0.5% vol/vol mixture of Irgacure 500 manufactured by Ciba-Geigy Chemicals. The resulting elastomeric material exhibited moderate elasticity and adhered to glass.

Where encapsulation of sacrificial layers is employed to fabricate the elastomer structure as described above in FIGS. 12-22, bonding of successive elastomeric layers can be accomplished by pouring uncured elastomer over a previously cured elastomeric layer and any sacrificial material patterned thereupon. Bonding between elastomer layers occurs due to interpenetration and reaction of the polymer chains of an uncured elastomer layer with the polymer chains of a cured elastomer layer. Subsequent curing of the elastomeric layer creates a monolithic elastomeric structure in which a bond is formed between the elastomeric layers.

Referring again to the first method of FIGS. 5 to 11B, first elastomeric layer 20 can be created by spin-coating an RTV mixture on microfabricated mold 10 at 2000 rpm for 30 seconds yielding a thickness of approximately 40 microns. Second elastomeric layer 22 can be created by spin-coating an RTV mixture on microfabricated mold 12. Both layers 20 and 22 can be separately baked or cured at about 80° C. for 1.5 hours. The second elastomeric layer 22 can be bonded onto first elastomeric layer 20 at about 80° C. for about 1.5 hours.

Micromachined molds 10 and 12 can be a patterned sacrificial layer on silicon wafers. In an exemplary aspect, a Shipley SJR 5740 sacrificial layer was spun at 2000 rpm patterned with a high resolution transparency film as a mask and then developed yielding an inverse channel of approximately 10 microns in height. When baked at approximately 200° C. for about 30 minutes, the sacrificial layer reflows and the inverse channels become rounded. Optionally, the molds can be treated with trimethylchlorosilane (TMCS) vapor for about a minute before each use in order to prevent adhesion of silicone rubber.

Dimensions of the Microfabricated Structures

Some flow channels (30, 32, 60 and 62) preferably have width-to-depth ratios of about 10:1. A non-exclusive list of other ranges of width-to-depth ratios in accordance with the present invention is 0.1:1 to 100:1, more preferably 1:1 to 50:1, more preferably 2:1 to 20:1, and most preferably 3:1 to 15:1. In an exemplary aspect, flow channels 30, 32, 60 and 62 have widths of about 1 to about 1000 microns. A non-exclusive list of other ranges of widths of flow channels in accordance with the present invention is about 0.01 to about 1000 microns, more preferably about 0.05 to about 1000 microns, more preferably about 0.2 to about 500 microns, more preferably about 1 to about 250 microns, and most preferably about 10 to about 200 microns. Exemplary channel widths include 0.1 μm, 1 μm, 2 μm, 5 μm, 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 210 μm, 220 μm, 230 μm, 240 μm, and 250 μm.

Flow channels 30, 32, 60, and 62 have depths of about 1 to about 100 microns. A non-exclusive list of other ranges of depths of flow channels in accordance with the present invention is about 0.01 to about 1000 microns, more preferably about 0.05 to about 500 microns, more preferably about 0.2 to about 250 microns, and more preferably about 1 to about 100 microns, more preferably 2 to 20 microns, and most preferably 5 to 10 microns. Exemplary channel depths include including 0.01 μm, 0.02 μm, 0.05 μm, 0.1 μm, 0.2 μm, 0.5 μm, 1 μm, 2 μm, 3 μm, 4 μm, 5 μm, 7.5 μm, 10 μm, 12.5 μm, 15 μm, 17.5 μm, 20 μm, 22.5 μm, 25 μm, 30 μm, 40 μm, 50 μm, 75 μm, 100 μm, 150 μm, 200 μm, and 250 μm.

The flow channels are not limited to these specific dimension ranges and examples given above, and can vary in width in order to affect the magnitude of force required to deflect the elastomeric segment. Elastomeric structures which include portions having channels of even greater width than described above are also contemplated by the present invention, and examples of applications of utilizing such wider flow channels include fluid reservoir and mixing channel structures (e.g., for mixing two or more solvent to produce an eluent).

Elastomeric layer 22 can be cast thick for mechanical stability. In an exemplary embodiment, layer 22 is about 50 microns to several centimeters thick, and more preferably approximately 4 mm thick. A non-exclusive list of ranges of thickness of the elastomer layer in accordance with other embodiments of the present invention is between about 0.1 micron to about 10 cm, 1 micron to 5 cm, 10 microns to 2 cm, and 100 microns to 10 mm.

Accordingly, elastomeric segment 25 of FIG. 11B separating flow channels 30 and 32 has a typical thickness of between about 0.01 and about 1000 microns, more preferably about 0.05 to about 500 microns, still more preferably about 0.2 to about 250, yet more preferably about 1 to about 100 microns, still yet more preferably about 2 to about 50 microns, and most preferably about 5 to about 40 microns. As such, the thickness of elastomeric layer 22 is about 100 times the thickness of elastomeric layer 20. Exemplary elastomeric segment thicknesses include 0.01 μm, 0.02 μm, 0.03 μm, 0.05 μm, 0.1 μm, 0.2 μm, 0.3 μm, 0.5 μm, 1 μm, 2 μm, 3 μm, 5 μm, 7.5 μm, 10 μm, 12.5 μm, 15 μm, 17.5 μm, 20 μm, 22.5 μm, 25 μm, 30 μm, 40 μm, 50 μm, 75 μm, 100 μm, 150 μm, 200 μm, 250 μm, 300 μm, 400 μm, 500 μm, 750 μm, and 1000 μm.

Similarly, first elastomeric layer 42 (FIG. 12) can have a preferred thickness about equal to that of elastomeric layer 20 or 22; second elastomeric layer 46 (FIG. 15) can have a preferred thickness about equal to that of elastomeric layer 20; and third elastomeric layer 50 (FIG. 19) can have a preferred thickness about equal to that of elastomeric layer 22.

Operation of the Microfabricated Components

FIGS. 11B and 11C together show the closing of a first flow channel by pressurizing a second flow channel (e.g., control system), with FIG. 11B (a front sectional view cutting through flow channel 32 in corresponding FIG. 11A), showing an open first flow channel 30; with FIG. 11C showing first flow channel 30 closed by pressurization of the second flow channel 32.

Referring to FIG. 11B, first flow channel 30 and second flow channel 32 are shown. Elastomeric segment 25 separates the flow channels, forming the top of first flow channel 30 and the bottom of second flow channel 32. As can be seen, flow channel 30 is “open”.

As can be seen in FIG. 11C, pressurization of flow channel 32 (either by gas or liquid introduced therein) causes elastomeric segment 25 to deflect downward, thereby pinching off flow channel 30. Accordingly, by varying the pressure in channel 32, an actuable valve system is provided such that flow channel 30 can be opened or closed by moving elastomeric segment 25 as desired. (For illustration purposes only, channel 30 in FIG. 11C is shown in a “mostly closed” position, rather than a “fully closed” position).

It is to be understood that exactly the same valve opening and closing methods can be achieved with flow channels 60 and 62. Since such valves are actuated by moving the roof of the channels themselves (i.e., moving elastomeric segment 25), valves and pumps produced by this technique have a truly zero dead volume, and switching valves made by this technique have a dead volume approximately equal to the active volume of the valve, for example, about 100×100×10 μm=100 pL. Such dead volumes and areas consumed by the moving elastomeric segment are approximately two orders of magnitude smaller than known conventional microvalves. Smaller and larger valves and switching valves are contemplated in the present invention, and a non-exclusive list of ranges of dead volume includes 1 aL to 1 μL, 100 aL to 100 nL, 1 fL to 10 nL, 100 fL to 1 nL, and 1 pL to 100 pL

The extremely small volumes capable of being delivered by pumps and valves in accordance with the present invention represent a substantial advantage. Specifically, the smallest known volumes of fluid capable of being manually metered is around 0.1 μl. The smallest known volumes capable of being metered by automated systems is about ten-times larger (1 μl). Utilizing pumps and valves of the present invention, volumes of liquid of 10 nl or smaller can routinely be metered and dispensed. The accurate metering of extremely small volumes of fluid enabled by the present invention allows chromatographic separation of an extremely small amount of the sample.

FIGS. 23a and 23b illustrate valve opening vs. applied pressure for a 100 μm wide first flow channel 30 and a 50 μm wide second flow channel 32, respectively. The elastomeric segment of this device was formed by a layer of General Electric Silicones RTV 615 having a thickness of approximately 30 μm and a Young's modulus of approximately 750 kPa. FIGS. 23a and 23b show the extent of opening of the valve to be substantially linear over most of the range of applied pressures.

Air pressure was applied to actuate the elastomeric segment of the device through a 10 cm long piece of plastic tubing having an outer diameter of 0.025″ connected to a 25 mm piece of stainless steel hypodermic tubing with an outer diameter of 0.025″ and an inner diameter of 0.013″. This tubing was placed into contact with the control channel by insertion into the elastomeric block in a direction normal to the control channel. Air pressure was applied to the hypodermic tubing from an external LHDA miniature solenoid valve manufactured by Lee Co.

The response of valves of the present invention is substantially linear over a large portion of its range of travel, with minimal hysteresis. While valves and pumps do not require linear actuation to open and close, linear response does allow valves to more easily be used as metering devices. In some applications, the opening of the valve is used to control flow rate by being partially actuated to a known degree of closure. Linear valve actuation makes it easier to determine the amount of actuation force required to close the valve to a desired degree of closure. Another benefit of linear actuation is that the force required for valve actuation can be easily determined from the pressure in the flow channel. If actuation is linear, increased pressure in the flow channel can be countered by adding the same pressure (force per unit area) to the actuated portion of the valve.

Control and Pump Systems

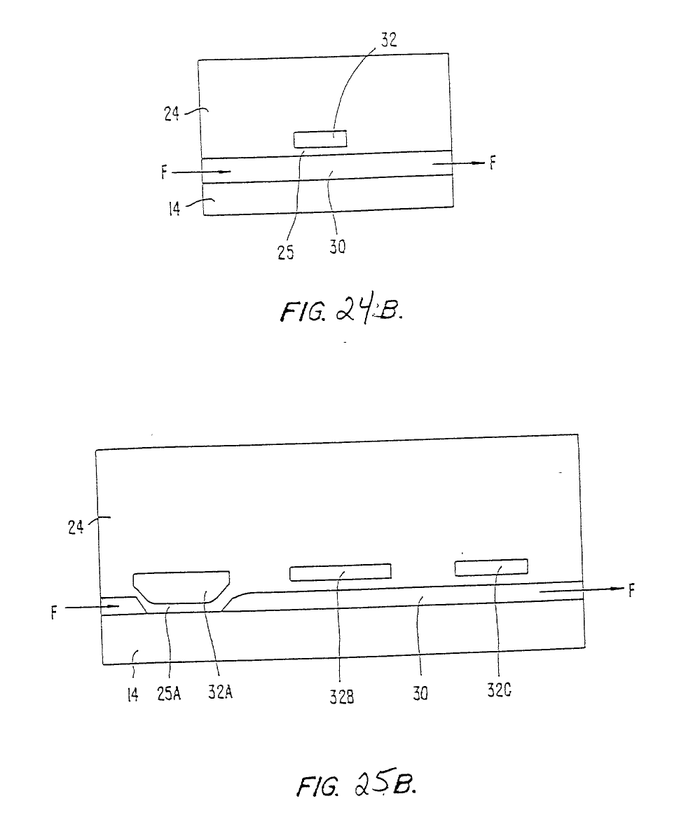

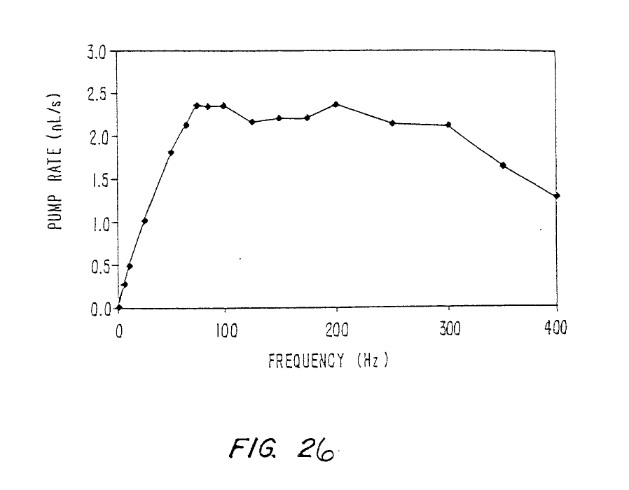

FIGS. 24A and 24B show views of a single on/off valve (e.g., flow control system), identical to the systems set forth above, (for example in FIG. 11A). FIGS. 25A and 23B shows a peristaltic pumping system (e.g., a material delivery system) comprised of a plurality of the single addressable on/off valves as seen in FIGS. 24A and 24B, but networked together. FIG. 26 is a graph showing experimentally achieved pumping rates vs. frequency for the peristaltic pumping system of FIGS. 25A and 25B.

Referring first to FIGS. 24A and 24B, a schematic of flow channels 30 and 32 is shown. Flow channel 30 preferably has a fluid (or gas) flow F passing therethrough. Flow channel 32, which crosses over flow channel 30, is pressurized such that elastomeric segment 25 separating the flow channels is depressed into the path of flow channel 30, shutting off the passage of flow F therethrough, as described above. As such, “flow channel” 32 can also be referred to as a “control line”, “control channel”, “control valve” or “control system” which actuates a single valve in flow channel 30.

Referring to FIGS. 25A and 25B, a system for peristaltic pumping is provided, as follows. A flow channel 30 has a plurality of generally parallel flow channels (i.e., control channels) 32A, 32B and 32C passing thereover. By pressurizing control line 32A, flow F through flow channel 30 is shut off under elastomeric segment 25A at the intersection of control line 32A and flow channel 30. Similarly, (but not shown), by pressurizing control line 32B, flow F through flow channel 30 is shut off under elastomeric segment 25B at the intersection of control line 32B and flow channel 30, etc. Each of control lines 32A, 32B, and 32C is separately addressable. Therefore, peristalsis can be actuated by the pattern of actuating 32A and 32C together, followed by 32A, followed by 32A and 32B together, followed by 32B, followed by 32B and C together, etc. This corresponds to a successive “101, 100, 110, 010, 011, 001” pattern, where “0” indicates “valve open” and “1” indicates “valve closed.” This peristaltic pattern is also known as a 120° pattern (referring to the phase angle of actuation between three valves). Other peristaltic patterns are equally possible, including 60° and 90° patterns.

Using this process, a pumping rate of 2.35 nL/s was measured by measuring the distance traveled by a column of water in thin (0.5 mm i.d.) tubing; with 100×100×10 μm valves under an actuation pressure of 40 kPa. As shown in FIG. 26, the pumping rate increased with actuation frequency until approximately at about 75 Hz, and from about 75 Hz to above 200 Hz the pumping rate was nearly constant. The valves and pumps are also quite durable and the elastomeric segment, control channels, or both have not been observed to fail. Moreover, none of the valves in the peristaltic pump described herein show any sign of wear or fatigue after more than 4 million actuations.

Suitable Polymer Materials

Allcock et al., Contemporary Polymer Chemistry, 2^{nd} Ed. describes elastomers in general as polymers existing at a temperature between their glass transition temperature and liquefaction temperature. Elastomeric materials exhibit elastic properties because the polymer chains readily undergo torsional motion to permit uncoiling of the backbone chains in response to a force, with the backbone chains recoiling to assume the prior shape in the absence of the force. In general, elastomers deform when force is applied, but then return to their original shape when the force is removed. The elasticity exhibited by elastomeric materials can be characterized by a Young's modulus. Elastomeric materials having a Young's modulus of between about 1 Pa to about 1 TPa, more preferably between about 10 Pa to about 100 GPa, more preferably between about 20 Pa to about 1 GPa, more preferably between about 50 Pa to about 10 MPa, and more preferably between about 100 Pa to about 1 MPa are useful in accordance with the present invention, although elastomeric materials having a Young's modulus outside of these ranges could also be utilized depending upon the needs of a particular application.

The microfluidic devices of the present invention can be fabricated from a wide variety of elastomers. For example, elastomeric layers 20, 22, 42, 46 and 50 can preferably be fabricated from silicone rubber. In one particular embodiment, the microfluidic devices of the present systems are fabricated from an elastomeric polymer such as GE RTV 615 (formulation), a vinyl-silane crosslinked (type) silicone elastomer (family). An important requirement for the preferred method of fabrication is the ability to produce layers of elastomers which can be bonded together. In the case of multilayer soft lithography, layers of elastomer can be cured separately and then bonded together. This scheme requires that cured layers possess sufficient reactivity to bond together. The layers can be of the same type which are capable of bonding to themselves, or they can be of two different types which are capable of bonding to each other. Other possibilities include the use an adhesive between layers and the use of thermoset elastomers.

Given the tremendous diversity of polymer chemistries, precursors, synthetic methods, reaction conditions, and potential additives, there are a huge number of possible elastomer systems that could be used to make monolithic elastomeric microfluidic devices of the present invention. Variations in the materials used most likely are driven by the need for particular material properties, e.g., stiffness, gas permeability, or temperature stability.

Common elastomeric polymers include, but are not limited to, polyisoprene, polybutadiene, polychloroprene, polyisobutylene, poly(styrene-butadiene-styrene), the polyurethanes, and silicones. The following is a non-exclusive list of elastomeric materials which can be utilized in connection with the present invention: polyisoprene, polybutadiene, polychloroprene, polyisobutylene, poly(styrene-butadiene-styrene), the polyurethanes, and silicone polymers; or poly(bis(fluoroalkoxy)phosphazene) (PNF, Eypel-F), poly(carborane-siloxanes) (Dexsil), poly(acrylonitrile-butadiene) (nitrile rubber), poly(1-butene), poly(chlorotrifluoroethylene-vinylidene fluoride) copolymers (Kel-F), poly(ethyl vinyl ether), poly(vinylidene fluoride), poly(vinylidene fluoride-hexafluoropropylene) copolymer (Viton), elastomeric compositions of polyvinylchloride (PVC), polysulfone, polycarbonate, polymethylmethacrylate (PMMA), and polytertrafluoroethylene (Teflon).

In addition, polymers incorporating materials such as chlorosilanes or methyl-,ethyl-, and phenylsilanes, and polydimethylsiloxane (PDMS) such as Dow Chemical Corp. Sylgard 182, 184 or 186, or aliphatic urethane diacrylates such as (but not limited to) Ebecryl 270 or Irr 245 from UCB Chemical can also be used.

In another embodiments of the present invention, elastomers can be “doped” with uncrosslinkable polymer chains of the same class. For instance RTV 615 can be diluted with GE SF96-50 Silicone Fluid. This serves to reduce the viscosity of the uncured elastomer and reduces the Young's modulus of the cured elastomer. Essentially, the crosslink-capable polymer chains are spread further apart by the addition of “inert” polymer chains, so this is called “dilution”. RTV 615 cures at up to 90% dilution, with a dramatic reduction in Young's modulus. Other examples of doping of elastomer material can include the introduction of electrically conducting or magnetic species.

Non-Elastomer Based Polymers

As discussed above, while elastomers are preferred materials for fabricating the microfluidic devices of the present invention, non-elastomer based microfluidic devices can also be used. In some applications, the microfluidic devices of the present invention utilize microfluidics based on conventional micro-electro-mechanical system (MEMS) technology. Methods of producing conventional MEMS microfluidic systems such as bulk micro-machining and surface micro-machining have been described, e.g., in Terry et al., A Gas Chromatographic Air Analyzer Fabricated on a Silicon Wafer, IEEE Trans. on Electron Devices, v. ED-26, pp. 1880-1886, 1979; and Berg et al., Micro Total Analysis Systems, New York, Kluwer, 1994.

Bulk micro-machining is a subtractive fabrication method whereby single crystal silicon is lithographically patterned and then etched to form three-dimensional structures. For example, bulk micromachining technology, which includes the use of glass wafer processing, silicon-to-glass wafer bonding, has been commonly used to fabricate individual microfluidic components. This glass-bonding technology has also been used to fabricate microfluidic systems.

Surface micro-machining is an additive method where layers of semiconductor-type materials such as polysilicon, silicon nitride, silicon dioxide, and various metals are sequentially added and patterned to make three-dimensional structures. Surface micromachining technology can be used to fabricate individual fluidic components as well as microfluidic systems with on-chip electronics. In addition, unlike bonded-type devices, hermetic channels can be built in a relatively simple manner using channel walls made of polysilicon (see, e.g., Webster et al., Monolithic Capillary Gel Electrophoresis Stage with On-Chip Detector, in International Conference on Micro Electromechanical Systems, MEMS 96, pp. 491-496, 1996), silicon nitride (see, e.g., Mastrangelo et al., Vacuum-Sealed Silicon Micromachined Incandescent Light Source, in Intl. Electron Devices Meeting, IDEM 89, pp. 503-506, 1989), and silicon dioxide.

In some applications, electrokinetic flow based microfluidics can be employed in the microfluidic chromatography devices of the present invention. Briefly, these systems direct reagents flow within an interconnected channel and/or chamber containing structure through the application of electrical fields to the reagents. The electrokinetic systems concomitantly regulate voltage gradients applied across at least two intersecting channels. Such systems are described, for example, in WO 96/04547 and U.S. Pat. No. 6,107,044, which are incorporated herein by reference in their entirety.

Microfluidic Chromatography

Carrying out chemical or biochemical analyses, syntheses or preparations, even at the simplest levels, requires one to perform a large number of separate manipulations on the material components of that analysis, synthesis or preparation, including measuring, aliquoting, transferring, diluting, concentrating, separating, detecting, etc. In this respect, microfluidic devices of the present invention are particularly useful in performing these manipulations in a microscale level. Chromatographic separation results depend on many factors which are known to one skilled in the art. These factors include, but not limited to, the adsorbent (i.e., solid stationary phase) chosen, polarity of the solvent, size of the column (both length and diameter) relative to the amount of material to be chromatographed, and the rate of elution.

In order to manipulate reagents (e.g., samples, eluents, etc.) within the microfabricate devices described herein, the overall microfluidic devices of the present invention can include a pumps, valves, various channels, and/or chambers. As stated above, pumps and valves generally are designed to controls the movement and direction of fluids containing such materials within flow channels of the microfluidic devices. Generally, pump and valve systems employ pressure or other known actuation systems to affect fluid movement and direction in flow channels. Preferably, the microfluidic devices of the present invention comprises the above described pump and valve systems to affect direction and transport of fluid within the microfluidic devices. Other fluid movement and direction controls for microfluidic devices are known in the art, including mechanical pumps and valves and electroosmotic fluid direction systems. Such fluid movement and direction controls are contemplated to be within the scope of the present invention. Electroosmotic fluid direction systems and controllers are described in detail in, e.g., U.S. Pat. No. 5,779,868, which is incorporated herein by reference in its entirety.

The stationary phase allows separation of an analyte in a solution and as such the selection of a particular stationary phase compound depends on the particular analyte to be separated. Useful stationary phases for separation of a particular class of analyte is well known to or can be readily determined by one skilled in the art.

Alternatively, the chromatography column can be a separately fabricated component which is then integrated with the microfabricated fluid delivery system. Advantages of this embodiment include the capability of using the microfabricated fluid delivery system with different chromatography columns and interchangeability of chromatography columns depending on the need.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A microfluidic device for separating an analyte from a sample fluid comprising:
(a) a microfabricated flow channel comprising:
(i) an inlet for introducing a material into said flow channel;
(ii) an outlet for removing the material from said flow channel;
(iii) a chromatography column portion located within said flow channel and in between the inlet and the outlet, and
(iv) a solid stationary phase within at least a portion of said chromatography column portion, wherein said solid stationary phase is capable of separating at least a portion of an analyte from a sample fluid; and
(b) a flow control system for regulating fluid flow through said flow channel.

2. The microfluidic device of claim 1, wherein said device is produced from a material comprising an elastomeric polymer.

3. The microfluidic device of claim 2, wherein said flow control system comprises:
(i) a flow control channel;
(ii) a flow control valve comprised of an elastomeric segment that is disposed in between said flow channel and said flow control channel, wherein said flow control valve is deflectable into or retractable from said flow channel upon which said flow control valve operates in response to an actuation force applied to said flow control channel, the elastomeric segment when positioned in said flow channel restricting fluid flow therethrough, and
(iii) a flow control channel actuation system operatively interconnected to said flow control channel for applying the actuation force to said flow control channel.

4. The microfluidic device of claim 3 further comprising:
a solid stationary phase inlet in fluid communication with said flow channel for introducing said solid stationary phase into said chromatography column portion;
a solid stationary phase inlet channel interconnecting said solid stationary phase inlet and said flow channel; and
a solid stationary phase inlet control valve comprised of an elastomeric segment that is disposed in between said solid stationary phase inlet channel and said control channel to regulate flow of solid stationary phase through said solid stationary phase inlet channel, wherein said solid stationary phase inlet control valve is deflectable into or retractable from said solid stationary phase inlet channel upon which said solid stationary phase inlet control valve operates in response to an actuation force applied to said control channel, the elastomeric segment of said solid stationary phase inlet control valve when positioned in said solid stationary phase inlet channel restricting flow of solid stationary phase material therethrough.

5. The microfluidic device of claim 3 further comprising:
a solid stationary phase reservoir in fluid communication with said flow channel for storing the solid stationary phase material; and
a solid stationary phase reservoir control valve comprised of an elastomeric segment that is disposed in between said solid stationary phase reservoir and said control channel to regulate flow of solid stationary phase into said flow channel, wherein said solid stationary phase reservoir control valve is deflectable into or retractable from said flow channel upon which said solid stationary phase reservoir control valve operates in response to an actuation force applied to said control channel, the elastomeric segment of said solid stationary phase reservoir control valve when positioned in said flow channel restricting flow of solid stationary phase material therethrough.

6. The microfluidic device of claim 4 further comprising:
an excess solid stationary phase outlet located downstream from said chromatography column portion and in fluid communication with said flow channel for removing any excess solid stationary phase flowing out of said chromatography column portion; and
an excess solid stationary phase outlet control valve comprised of an elastomeric segment that is disposed in between said excess solid stationary phase outlet and said control channel to regulate flow of solid stationary phase from said chromatography column portion to said excess solid stationary phase outlet, wherein said excess solid stationary phase outlet control valve is deflectable into or retractable from said flow channel upon which said excess solid stationary phase outlet control valve operates in response to an actuation force applied to said control channel, the elastomeric segment of said excess solid stationary phase outlet control valve when positioned in said flow channel restricting flow of excess solid stationary phase material therethrough.

7. The microfluidic device of claim 1 further comprising a sample reservoir located upstream from said chromatography column portion and in fluid communication with said flow channel.

8. The microfluidic device of claim 3 further comprising:
a sample inlet control valve comprised of an elastomeric segment that is disposed in between said inlet and said control channel to regulate flow of the sample into said flow channel, wherein said sample inlet control valve is deflectable into or retractable from said flow channel upon which said sample inlet control valve operates in response to an actuation force applied to said control channel, the elastomeric segment of said sample inlet control valve when positioned in said flow channel restricting sample flow therethrough.

9. The microfluidic device of claim 3 further comprising:
an eluent inlet located upstream from said chromatography column portion and in fluid communication with said flow channel for introducing an eluent into said chromatography column portion; and
an eluent inlet control valve comprised of an elastomeric segment that is disposed in between said eluent inlet and said control channel to regulate flow of the eluent into said flow channel, wherein said eluent inlet control valve is deflectable into or retractable from said flow channel upon which said eluent inlet control valve operates in response to an actuation force applied to said control channel, the elastomeric segment of said eluent inlet control valve when positioned in said flow channel restricting eluent flow therethrough.

10. The microfluidic device of claim 3 further comprising an eluent reservoir located upstream from said chromatography column portion and in fluid communication with said flow channel.

11. The microfluidic device of claim 1, wherein said microfabricated flow channel comprises a plurality of said chromatography column portions.

12. The microfluidic device of claim 1, wherein the distal end of said chromatography column portion is tapered for preventing or reducing the amount of solid stationary phase from flowing out of said chromatography column portion.

13. The microfluidic device of claim 3, wherein said chromatography column portion comprises a microfabricated rotary channel in fluid communication with said flow channel, wherein said rotary channel comprises:
a rotary channel inlet;
a rotary channel outlet;
a rotary inlet control valve comprised of an elastomeric segment disposed in between said rotary channel inlet and said control channel to regulate fluid flow into said rotary channel, wherein said rotary inlet control valve is deflectable into or retractable from said rotary channel inlet upon which said rotary inlet control valve operates in response to an actuation force applied to said control channel, said elastomeric segment of said rotary inlet control valve when positioned in said rotary channel inlet restricting fluid flow therethrough;
a rotary outlet control valve comprised of an elastomeric segment disposed in between said rotary channel outlet and said control channel to regulate fluid flow out of said rotary channel, wherein said rotary outlet control valve is deflectable into or retractable from said rotary channel outlet upon which said rotary outlet control valve operates in response to an actuation force applied to said control channel, said elastomeric segment of said rotary control channel outlet valve when positioned in said rotary channel outlet restricting fluid flow therethrough; and
a rotary pump valve comprised of an elastomeric segment disposed in between said rotary channel and said control channel to regulate fluid flow through said rotary channel, wherein said rotary pump valve is deflectable into or retractable from said rotary channel upon which said rotary pump valve operates in response to an actuation force applied to said control channel, said elastomeric segment of said rotary pump valve when positioned in said rotary channel restricting fluid flow therethrough.

14. A method for separating an analyte from a sample solution, said method comprising the steps of:
(a) introducing a sample solution into a microfluidic device comprising:
(i) a microfabricated flow channel comprising:
(A) an inlet for introducing a material into said flow channel;
(B) an outlet for removing the material from said flow channel;
(C) a chromatography column portion located within said flow channel and in between the inlet and the outlet, and
(D) a solid stationary phase within at least a portion of said chromatography column portion, wherein said solid stationary phase is capable of separating at least a portion of an analyte from a sample fluid; and
(ii) a flow control system for regulating fluid flow through said flow channel; and
(b) eluting the sample solution through the chromatography column portion with an eluent using the flow control system, whereby at least a portion of the analyte is separated from the sample solution.

15. The method of claim 14, wherein said microfluidic device is produced from a material comprising an elastomeric polymer.

16. The method of claim 15, wherein the flow control system comprises:
(i) a flow control channel;
(ii) a flow control valve comprised of an elastomeric segment that is disposed in between the flow channel and the flow control channel, wherein the flow control valve is deflectable into or retractable from the flow channel upon which the flow control valve operates in response to an actuation force applied to the flow control channel, the elastomeric segment when positioned in the flow channel restricting fluid flow therethrough, and
(iii) a flow control channel actuation system operatively interconnected to the flow control channel for applying the actuation force to the flow control channel.

17. The method of claim 16, wherein the sample solution is eluted through the chromatography column by actuating the one or more of the control control channels.

18. The method of claim 16 further comprising placing the solid stationary phase into the chromatography column portion prior to introducing the sample solution into the chromatography column portion.

19. The method of claim 18, wherein the solid stationary phase is placed into the chromatography column portion using the flow control system.

20. The method of claim 18, wherein the microfluidic device further comprises:
a solid stationary phase inlet in fluid communication with said flow channel for introducing said solid stationary phase into said chromatography column portion;
a solid stationary phase inlet channel interconnecting said solid stationary phase inlet and said flow channel;
a solid stationary phase inlet control valve comprised of an elastomeric segment that is disposed in between said solid stationary phase inlet channel and said control channel to regulate flow of solid stationary phase through said solid stationary phase inlet channel, wherein said solid stationary phase inlet control valve is deflectable into or retractable from said solid stationary phase inlet channel upon which said solid stationary phase inlet control valve operates in response to an actuation force applied to said control channel, the elastomeric segment of said solid stationary phase inlet control valve when positioned in said solid stationary phase inlet channel restricting flow of solid stationary phase material therethrough.

21. The method of claim 16, wherein the chromatography column portion comprises a microfabricated rotary channel in fluid communication with the flow channel, wherein the rotary channel comprises:
a rotary channel inlet;
a rotary channel outlet;
a rotary inlet control valve comprised of an elastomeric segment disposed in between the rotary channel inlet and the control channel to regulate fluid flow into the rotary channel, wherein the rotary inlet control valve is deflectable into or retractable from the rotary channel inlet upon which the rotary inlet control valve operates in response to an actuation force applied to the control channel, the elastomeric segment of the rotary inlet control valve when positioned in the rotary channel inlet restricting fluid flow therethrough;
a rotary outlet control valve comprised of an elastomeric segment disposed in between the rotary channel outlet and the control channel to regulate fluid flow out of the rotary channel, wherein the rotary outlet control valve is deflectable into or retractable from the rotary channel outlet upon which the rotary outlet control valve operates in response to an actuation force applied to the control channel, the elastomeric segment of the rotary control channel outlet valve when positioned in the rotary channel outlet restricting fluid flow therethrough; and
a rotary pump valve comprised of an elastomeric segment disposed in between the rotary channel and the control channel to regulate fluid flow through the rotary channel, wherein the rotary pump valve is deflectable into or retractable from the rotary channel upon which the rotary pump valve operates in response to an actuation force applied to the control channel, the elastomeric segment of the rotary pump valve when positioned in the rotary channel restricting fluid flow therethrough.

22. The method of claim 21 further comprising:
introducing the sample solution into the rotary channel;
eluting a first eluent through the rotary channel to removed materials that are not bound to the solid stationary phase that is present within the rotary channel; and
eluting a second eluent through the rotary channel to removed materials that were bound to the solid stationary phase.

23. The method of claim 22 further comprising actuating both of the a rotary outlet control valve and the rotary inlet control valve after introducing the sample solution into the rotary channel and circulating the sample solution through the rotary channel prior to said step of eluting with the first eluent.

24. The method of claim 22 further comprising actuating both of the rotary outlet control valve and the rotary inlet control valve after introducing the second eluent into the rotary channel and circulating the second eluent through the rotary channel prior to removing the material from the rotary channel.
